(19) United States
(12) Patent Application Publication
(10) Pub. No.: US 2008/0109361 A1
(43) Pub. Date: May 8, 2008

(54) HEALTH RECORD ACCESS SYSTEM AND METHOD

(75) Inventors: Prem S. Urali, Redmond, WA (US); Goutham Sukumar, Sammamish, WA (US); Dmitriy Stoyanov Mitchev, Toronto (CA)

Correspondence Address: AXIOS LAW GROUP. PLLC, 1525 FOURTH AVENUE, SUITE 800, SEATTLE, WA, 98101, US

(73) Assignee: HEALTHUNITY CORPORATION, Bellevue, WA (US)

(21) Appl. No.: 11/937,431

(22) Filed: Nov. 8, 2007

Related U.S. Application Data
(60) Provisional application No. 60/864,897, filed on Nov. 8, 2006.
(60) Provisional application No. 60/866,696, filed on Nov. 21, 2006.

(51) Int. Cl. G06Q 50/00; H04K 1/00

(52) U.S. Cl. 705/51; 705/2

(57) ABSTRACT

A record access system and method are provided herein.

### RELATED APPLICATIONS

This application claims priority to U.S. Provisional Application 60/864,897 filed Nov. 8, 2006 and U.S. Provisional Application 60/866,696 filed Nov. 21, 2006. The foregoing applications are hereby incorporated by reference in their entirety as if fully set forth herein.

### FIELD

The present invention generally relates to digital communications, and more specifically to digital communications for maintaining digital data.

### BACKGROUND

In a widely distributed network which connects different entities that share data between themselves, there is a need for a mechanism that enables each entity in the network to access data generated from other entities even when the source entities are not readily available or accessible.

Communications between electronic devices have also improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term Internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Networked appliances are generally a combination of hardware and software components that provide, among other functionality, communications between different organizations.

Data is a valuable asset to organizations. Organizations routinely use data contained in their computer systems for various purposes such as performing analyses, making decisions etc. Data may be exchanged between organizations to aid each other in conducting business. For example, in a clinical setting, organizations such as hospitals and clinician practices may exchange patient treatment data to help provide better care for patients and also to save costs and increase efficiency by eliminating duplicate work.

To enable trusted communications between different entities in a peer-to-peer network, various mechanisms may ensure that one entity can locate the correct entity to communicate with and to ensure that the located entity on the other side of the communication is the correct one.

Networked appliances are generally a combination of hardware and software components that provide, among other functionality, communications between different organizations.

There are a number of existing technologies that can enable secure communications between appliances as well as between end users attached to such appliances.

One such technology is digital certificate technology (or public key infrastructure technology). Digital certificates may be used to authenticate the destination and source appliances of the communication, as well as to identify the trusted end-users at the appliance. However, digital certificates are usually hard to manage and require additional investments in infrastructure for supporting a complete system for issuing as well as revoking the same. In addition, mechanisms for distributing and tracking digital certificates to all the end users of a system is relatively expensive and does not allow end users to move between workstations easily. Mechanisms for validating digital certificates also require investment in infrastructure, processes and management.

Another alternative mechanism for managing user and appliance identities may be a client/server system where a central database manages all the user identities in the system as well as provide mechanisms to authenticate users centrally. In such a system, the central authentication system could become a bottleneck on which all the peers will have to rely. Additionally, presence of such a central system may have negative political, managerial and/or cost implications.

However, existing systems and methods do not adequately address the issues of individual control of private information that people may wish to control from being sent out and/or received.

### BRIEF DESCRIPTION OF THE DRAWINGS

FIG. 1 is a system diagram of a number of devices in a network in accordance with one embodiment.

FIG. 2 is a block diagram of a network services interface device that provides an exemplary operating environment for one embodiment.

FIG. 3 is a block diagram of an appliance that provides an exemplary operating environment for one embodiment.

FIG. 4 is a diagram illustrating the actions taken by devices in a secure communications system to register an appliance in accordance with one embodiment.

FIG. 5 is a flow diagram illustrating a registration routine in accordance with one embodiment.

FIG. 6 is a diagram illustrating the actions taken by devices in a secure communications system for sending a secure message in accordance with one embodiment.

FIG. 7 is a flow diagram illustrating an introduced secure message routine in a sending appliance in accordance with one embodiment.

FIG. 8 is a flow diagram illustrating an introduced secure message routine on the network services interface in accordance with one embodiment.

FIG. 9 is a flow diagram illustrating an introduced secure message routine on a receiving appliance in accordance with one embodiment.

FIG. 10 is a diagram of the actions by devices in a secure communications system for sending a secure message between persons in accordance with one embodiment.

FIG. 11 is a flow diagram illustrating the person-to-person secure message processing on a receiving appliance in accordance with one embodiment.

FIG. 12 is a flow diagram illustrating service registration between network devices in accordance with one embodiment.

FIG. 13 is a diagram of the actions by devices in a virtual services system for performing a local service in accordance with one embodiment.

FIG. 14 is a diagram of the actions by devices in a virtual services system for performing a remote service in accordance with one embodiment.

FIG. 15 is a flow diagram illustrating a processing a service request in accordance with one embodiment.

FIG. 16 is a diagram of the actions by devices in a data storage system for registering a patient in accordance with one embodiment.

FIG. 17 is a diagram of the actions by devices in a data storage system for handling a document in accordance with one embodiment.

FIG. 18 is a flow diagram illustrating a document handling routine in accordance with one embodiment.

FIGS. 19-21 are diagrams of the actions by devices in a data storage system for looking up a document in accordance with various embodiments.

FIG. 22 is a flow diagram illustrating a document retrieval subroutine in accordance with one embodiment.

FIG. 23 is a flow diagram illustrating a document pre-fetch routine in accordance with one embodiment.

FIG. 24 illustrates an example user interface for controlling information flow in accordance with various embodiments.

FIG. 25 illustrates an exemplary medical record transmission processing routine in accordance with various embodiments.

FIG. 26 illustrates an exemplary medical record receipt processing routine in accordance with various embodiments.

FIG. 27 illustrates a patient authentication routine, in accordance with various embodiments.

FIG. 28 illustrates a patient sign-on routine, in accordance with various embodiments.

FIG. 29 illustrates an access credential generation subroutine, in accordance with various embodiments.

FIG. 30 is a diagram illustrating user registration actions taken by a first health provider appliance, a user device, and an NSI, in accordance with various embodiments.

FIG. 31 is a user registration routine, in accordance with various embodiments.

### DESCRIPTION

Illustrative embodiments presented herein include, but are not limited to, systems and methods for health record access

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

In various embodiments described below, privacy “gates” are introduced into the record sharing environment to control the flow of records between nodes of the network. Outgoing gates may utilize attributes and/or metadata of a record in the system as a way of filtering out that record being shared by a practice. Likewise, incoming gates act to filter records received from other parts of the network.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Organizations may like to leverage the ubiquity of the Internet and the breadth of connectivity it offers to propagate data between different divisions within the organization and also share data with external organizations to streamline the day to day operation of the business. For example, a particular law enforcement agency may wish to share information about criminals or suspects with other agencies in the same region to ensure swift and accurate decisions to be made when the criminal or suspect is encountered. As the same individual is encountered in various locations in the region, each agency may collect and maintain information about the person. As more and more information is collected about the individual, such information is propagated to other agencies in the same region. Besides making the information readily available to other agencies, this scheme also ensures that information about any one individual may be retrieved from multiple locations in the region, thus providing a higher level of redundancy than that is possible for a central or local storage infrastructure. An extension to the scheme also proposes a design whereby information is proactively propagated to those nodes in the network that anticipate the need for having such documents.

In the context of a healthcare information network, using the above scheme, clinical practices may exchange information about patients with other practices in the same region which also are known to have the same patient registered there. As information changes or is added to the patients records, it is also continuously propagated to other practices, thereby providing multiple locations in the region where the same patients information may reside. If the information systems at one of the practices were to fail or be otherwise unavailable, data about patients are still accessible from other practices in the network. In addition, any provider location that does not hold the patient records for a specific patient, but anticipates the need for such documents to be made available, can request a synchronization of such documents from locations from where they are available.

As can be seen from the redundant data sharing model described above, it may be possible for information to flow from one provider to another with little or no control by patients and providers. However, by utilizing both outgoing gates and incoming gates at a patient and a provider level, it is possible to create a well managed system that shares appropriately between provider practices in accordance and compliance with various policies that may restrict or control such sharing.

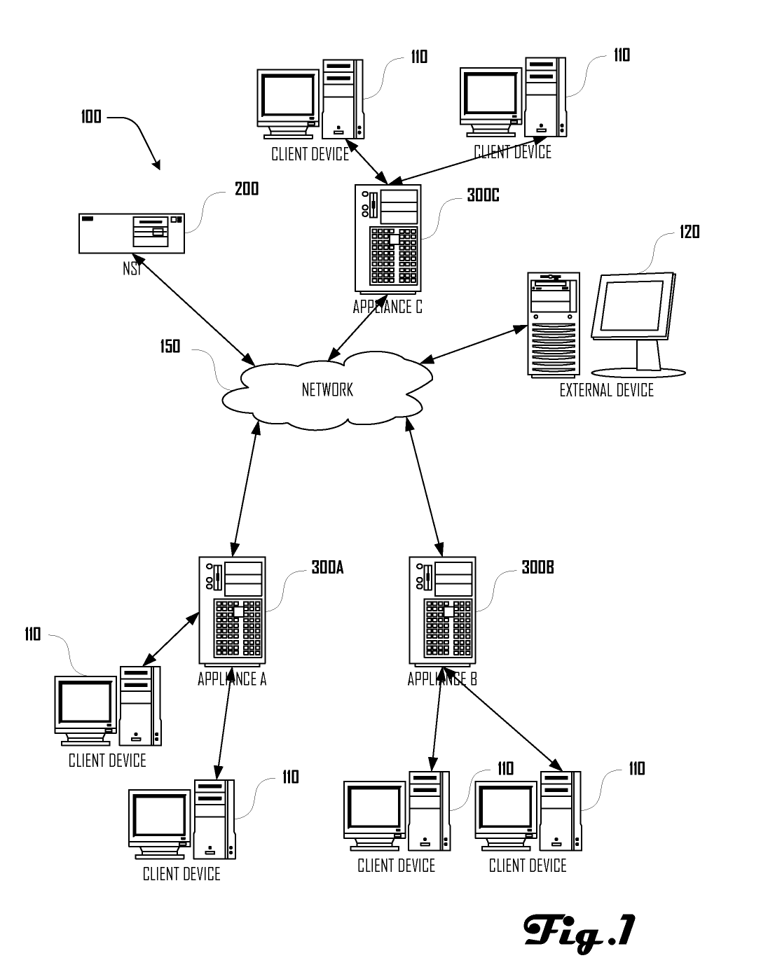

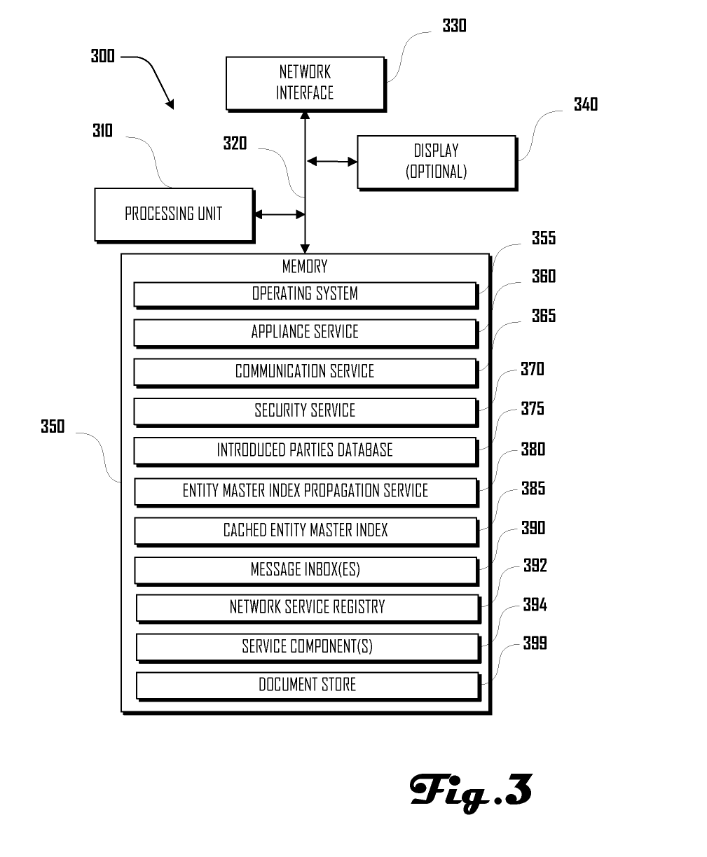

FIG. 1 illustrates a network where appliances 300 belonging to different organizations participate in communications with one another using peer-to-peer communications (or other forms of electronic communications). In FIG. 1, Organizations exchange information between one another. Each organization may have a corresponding Appliance 300A-C, or alternatively may be associated with an appliance that is shared between different organizations (not shown). An Appliance 300 (illustrated in FIG. 3 and described below) is a computer or device that contains the software services used by an organization to communicate with another organization. The client devices 110 may comprise computers and/or programs/applications which expose the services provided by the system 100 to the human users, or may also include programs that integrate data from other applications that reside within the organizations or outside them.

The secure communications system 100 (“system”) represents a set of technologies which enable each of the Appliances 300A-C to exchange messages with one another securely and privately on behalf of the organization that is represented by the appliance. The Network Services Infrastructure 200 (“NSI”) may include software services as well as hardware that enable the coordination of the communications between the different appliances 300A-C.

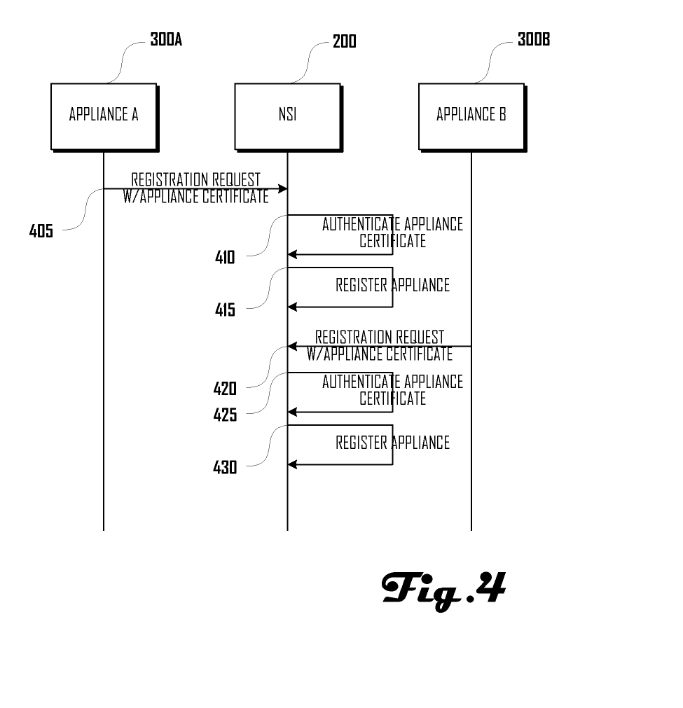

In one exemplary embodiment, any given pair of appliances 300A-C communicating with each other in a peer-to-peer fashion can mutually authenticate each other initially with the help of NSI 200 that introduces the appliances to each other. Once the mutual introduction is performed, the appliances can communicate with each other securely independent of the NSI 200 (see FIG. 4 and below).

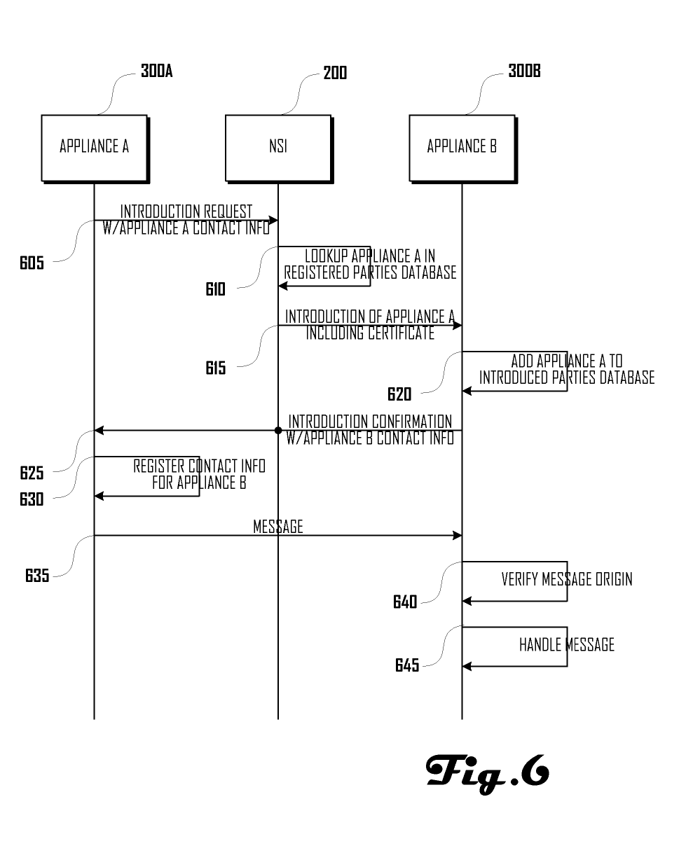

Once the introduction is performed, the communication can be two-way, with no restriction on which appliance has to initiate it (see FIG. 6 and below). The only times when the NSI 200 may be involved is when one of the appliances fails to establish communication with the other. For example, when one appliance fails/ceases to respond and the other appliance becomes unable to send a request to the failed appliance. Alternately, if the dynamically assigned Internet address of one Appliance 300A-C changes and this prevents the other appliance from reaching the changed Appliance 300A-C using the earlier Internet address.

When an Appliance 300A-C fails to connect to another already introduced Appliance 300A-C at the known Internet address, it contacts the NSI 200 to find the new location of the target Appliance 300A-C. The Appliance 300A-C will continue to periodically check with the NSI 200 until the Internet address provided by the NSI 200 proves to be useful in contacting the target Appliance 300A-C.

When any Appliance 300A-C detects a failure or a “resetting” event for itself, such as being restarted, having the Internet address changed, or the like, it performs a registration with the NSI 200. This updates the NSI 200 with the information needed by other appliances to reach the registered appliance.

If an Appliance 300A-C is known to be compromised (theft or other malicious event), the NSI 200 can immediately remove the compromised appliance from the list of known appliances, thus preventing other appliances from interacting with the compromised appliance or vice-a-versa. Such prohibition of communications for any source other than one in the list of known appliances may be implemented at any level, including, but not limited to the application's refusal to process any such communication or dynamically configuring software or hardware firewall mechanisms to ignore communications from unknown appliances and sources.

The NSI 200 can also send a message to all the other appliances (since it knows the location of each of the appliances) notifying them of the compromise, thus causing them to clear their respective available appliance lists.

In one embodiment, end users may perform trusted communications with each other as follows. A central repository, called the Entity Master Index 275 is maintained in the NSI 200 which contains the list of all the trusted end-users in the network. This list of trusted end-users may be referred to as the “Global Address Book” of the system.

In addition to the address book, a “Location Map” list is also maintained as part of the Entity Master Index 275 at the NSI 200 which associates each end user with the different appliances where the respective end user is located. For example, Dr. John Smith is a physician with details present in the Global Address Book. However, Dr. Smith may practice at two separate locations, Clinic A and Clinic B. In this case, besides having his name and address shown in the Global Address Book, Dr. John smith may also have two records in the “Location Map”, one associating him with Clinic A and the other associating him with Clinic B.

The Global Address Book as well as the Location Map may be optionally propagated to the individual appliances 300A-C periodically by the NSI 200.

At each Appliance 300A-C, an administrator may map the local appliance users to one or more entities in the Global Address book. This is the Local Identity Map (not shown).

When a user requires sending a secure message to another user in the network, he/she performs a lookup in the Global Address Book to select the recipient(s) of the message. When the message is sent, the underlying secure communications subsystem uses the Location Map to determine the Appliance 300A-C to which the message needs to be routed, and sends the message optionally in an encrypted form.

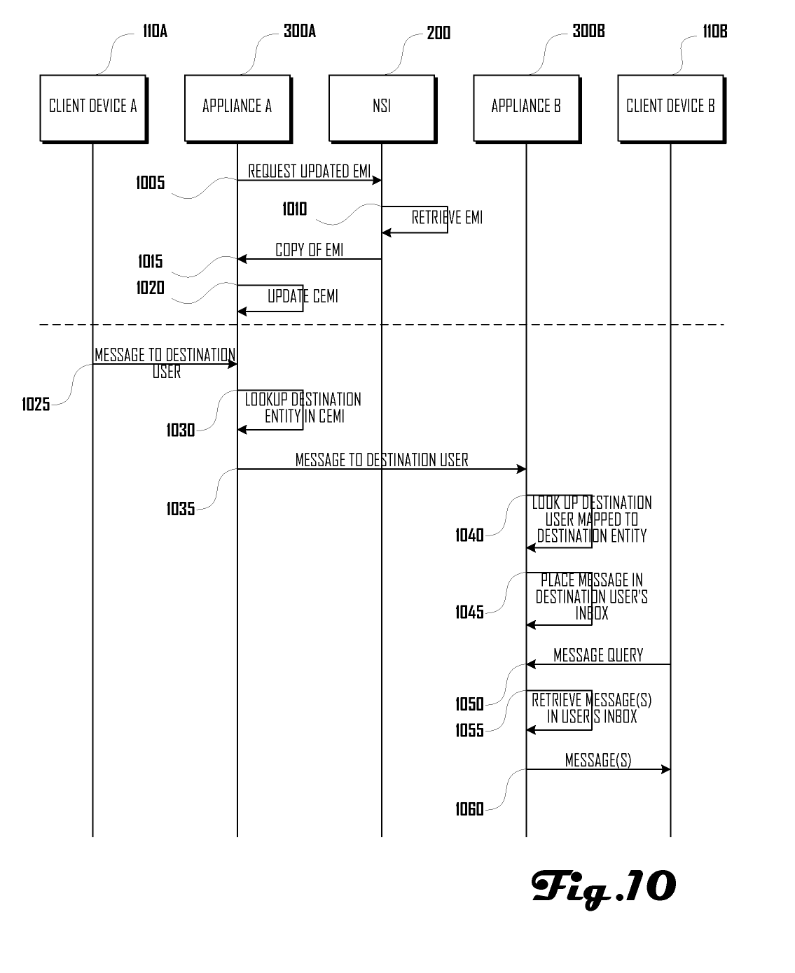

At the receiving end, the receiving Appliance 300A-C looks up the Local Identity Map to determine which end user(s) of the appliance are mapped to the Global Address Book entry to which the message is addressed. Once it finds the appliance user(s) mapped to the recipient(s), it copies the message to the inbox of the recipient user(s), who then has access to the secure communication (see FIG. 10, and description below).

In the context of a healthcare scenario, the components in FIG. 1 may correspond to the following specific instances. Each organization may correspond to healthcare providers, health-related services or other entities that deal with and needs to exchange healthcare related information. Each Appliance 300A-C may correspond to the hardware on which the software services that, in addition to other functions enable communication between the corresponding organization and other organizations in the network.

Client devices 110 may correspond to computing device, programs or web portals that expose the information and functionality of the system 100 to end users or those programs or software systems that exchange data between the system and other internal information systems at an organization.

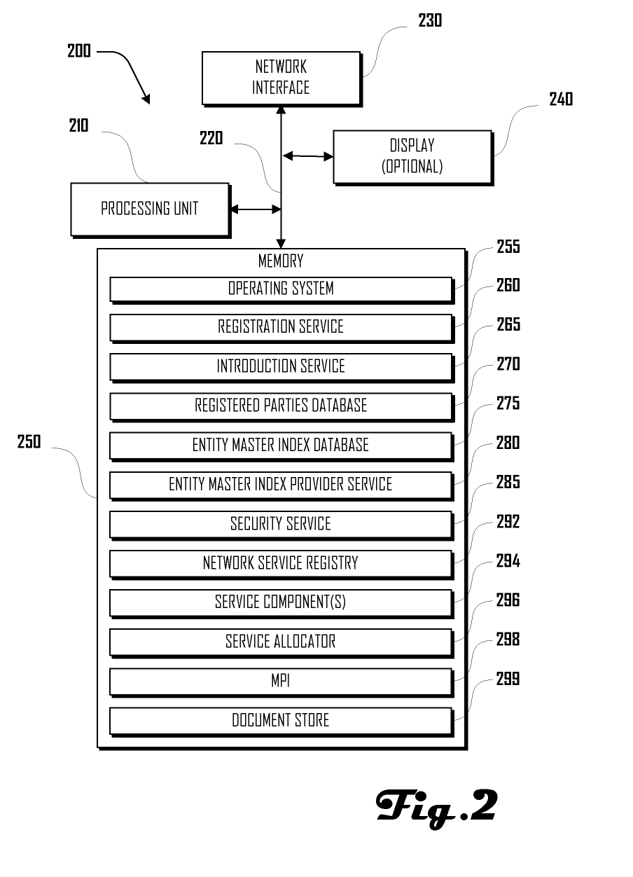

To show the operations of such communication networks, FIG. 1 illustrates an exemplary integrated secure communication system 100 having a number of devices used in exemplary embodiments. FIG. 1 illustrates a Network Service Infrastructure Device (“NSI”) 200 (illustrated in FIG. 2 and described below), a first second, and third appliance 300A, 300B, 300C (illustrated in FIG. 3 as an exemplary appliance 300 and described below), a network 150, such as a wired or wireless communications network, and an external device 120. Also in communication with the appliances 300A-C are a number of client devices 110.

In alternate embodiments, there may be more appliances 300, NSI 200 or client devices 110. In further embodiments, the roles of one or more of an appliance 300, client device 110, NSI and/or an external device 120 may be performed by an integrated device (not shown) or may be distributed across multiple other devices (not shown). In still further embodiments, still additional devices (not shown) may be utilized in the communication system 100.

In one example embodiment, different components of the system 100 may be used in a healthcare scenario, enabling interaction between different organizations using the Internet in a secure and trusted fashion. For example a hospital could use Appliance A 300A, a physician could use Appliance B 300B and a laboratory could use Appliance C 300C (other practices, and laboratories may be included in more complicated scenarios) to collaborate securely with one another over a network 150 (e.g., the Internet or the like). All of the above Appliances 300A-C may use the NSI 200 for coordinating the communication between them.

FIG. 2 illustrates several components of an exemplary NSI 200. In some embodiments, the NSI 200 may include many more components than those shown in FIG. 2. However, it is not necessary that all of these generally conventional components be shown in order to disclose an illustrative embodiment. As shown in FIG. 2, the NSI 200 includes a network interface 230 for connecting to the network 150. Those of ordinary skill in the art will appreciate that the network interface 230 includes the necessary circuitry for such a connection and is constructed for use with the appropriate protocol.

The NSI 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for registration service 260, introduction service 265, registered parties database 270, entity master index database 275, entity master index provider service 280, and security service 285. In addition, the memory 250 also stores an operating system 255. It will be appreciated that these software components may be loaded from a computer readable medium into memory 250 of the NSI 200 using a drive mechanism (not shown) associated with a computer readable medium, such as a floppy disc, tape, DVD/CD-ROM drive, memory card, via the network interface 230 or the like.

Although an exemplary NSI 200 has been described that generally conforms to conventional general purpose computing devices, those of ordinary skill in the art will appreciate that a NSI 200 may be any of a great number of devices capable of communicating with the network 150 or with the appliances 300.

FIG. 3 illustrates several components of an exemplary appliance 300. In some embodiments, the appliance 300 may include many more components than those shown in FIG. 3. However, it is not necessary that all of these generally conventional components be shown in order to disclose an illustrative embodiment. As shown in FIG. 3, the appliance 300 includes a network interface 330 for connecting to the network 150. Those of ordinary skill in the art will appreciate that the network interface 330 includes the necessary circuitry for such a connection and is constructed for use with the appropriate protocol.

The appliance 300 also includes a processing unit 310, a memory 350 and may include an optional display 340, all interconnected along with the network interface 330 via a bus 320. The memory 350 generally comprises a RAM, a ROM, and a permanent mass storage device, such as a disk drive. The memory 350 stores program code for appliance service 360, communication service 365, security service 370, introduced parties database 375, entity master index propagation service 380, cached entity master index 385, and message inbox(es) 390. It will be appreciated that these software components may be loaded from a computer readable medium into memory 350 of the appliance 300 using a drive mechanism (not shown) associated with a computer readable medium, such as a floppy disc, tape, DVD/CD-ROM drive, memory card, via the network interface 330 or the like.

Although an exemplary appliance 300 has been described that generally conforms to conventional general purpose computing devices, those of ordinary skill in the art will appreciate that an appliance 300 may be any of a great number of devices capable of communicating with the network 150 or with NSI 200.

FIGS. 4-11 illustrate exemplary steps to process secure communications in an exemplary secure communication system 100. Some transactions in the secure communication system 100 may be more or differently networked than others. Accordingly, in some embodiments, the number and types of devices may vary.

Appliance Registration:

When two appliances 300A-C from different organizations desire to communicate between themselves, they use the authenticated and introduced model of communication to accomplish it. Before such communication can work, the system needs to ensure that each appliance is registered with the NSI 200. This is achieved by the process of appliance registration.

FIG. 4 depicts an exemplary registration process for Appliance A 300A and Appliance B 300B. On startup, the Appliance Service application 360 on Appliance A 300A sends 405 a request to the Registration Service 260 on the Network Service Infrastructure 200 to register itself. When the Registration Service 260 receives a request, it authenticates 410 the certificate associated with the appliance and if found to be authentic, updates 415 the Registered Parties Database 270.

A similar series of steps are performed for other appliances such as Appliance B 300B. Appliance B 300B sends 420 a request to the Registration Service 260 on the Network Service Infrastructure 200 to register itself. When the Registration Service 260 receives a request, it authenticates 425 the certificate associated with the appliance and if found to be authentic, updates 430 the Registered Parties Database 270.

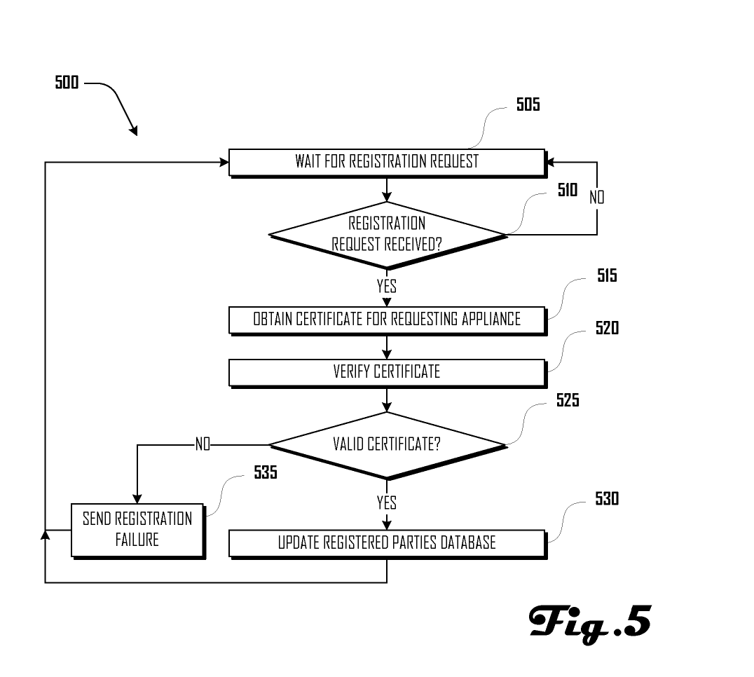

FIG. 5 illustrating an exemplary registration routine 500 on the NSI 200. Registration routine 500 begins at block 505 where the routine 500 waits for a registration request (e.g., from an Appliance 300). Next, in decision block 510 a determination is made where a registration request was received, if so, processing proceeds to block 515. Otherwise processing cycles back to block 505.

In block 515 a digital certificate of the requesting appliance 300 is obtained. In block 520, the certificate is verified. Next, in decision block 525 a determination is made whether the certificate is valid (e.g., corresponds to the requester, has not been revoked, has not expired and the like). If the certificate is valid, process continues to block 530, where the registered parties database 270 is updated with the appliance's certificate. If the certificate was not valid, a registration failure is sent to the requester in block 535. Routine 500, in any case, cycles back to block 505 where it waits for a new request.

Introduction and Communication:

Once two appliances have been introduced, they may communicate with each other. The origin appliance can begin to communicate with the destination appliance as long as both of them continue to use the same Internet address. A reintroduction is initiated if any of the appliances experiences a change in the Internet address, or any other failure during the course of communications. This mode of introduced communications is depicted by FIG. 6.

In FIG. 6, when appliance A 300A desires to communicate with Appliance B 300B, the address of which is not known, the following are the sequence of events that take place. Appliance A 300A requests 605 of the Introduction service 265 in the NSI 200 to be introduced to appliance B 300B. Introduction service 265 looks up 610 the Registered Parties Database 270 to find the address of appliance B 300B. Introduction service 265 then contacts 615 Appliance B 300B with information about Appliance A 300A. Appliance Service 360 on Appliance B 300B enters 620 the address of Appliance A 300A into its own Introduced Parties Database 375.

Application Service 360 might also perform additional activities such as configuring other mechanisms (such as a configurable software or hardware firewall) that aid in filtering out communications from unknown sources.

Introduction service 265 obtains an introduction confirmation and forwards 625 the result of the introduction process to Appliance A 300A, also including the current contact address of Appliance B 300B. Appliance A 300A registers 630 the address of Appliance B 300B in its Introduced Parties Database 375. Communication service 365 at Appliance A 300A sends 635 the communication/message to the Communication service 365 at Appliance B 300B. Communication service 365 at Appliance B 300B looks up and validates 640 the address of Appliance A 300A in its local Introduced Parties Database 375, finds the source of the communication to be valid and handles 645 the message.

This introduced mode of communication serves a number of purposes. It ensures that any change in the address of a node does not cause inter-node communications to fail. It also ensures that in case of a node being compromised, it can be isolated from the rest of the network. Additionally, it also ensures that the identity of each node is authenticated before any other nodes are allowed to communicate with it, as well as before it is allowed to communicate with any other node.

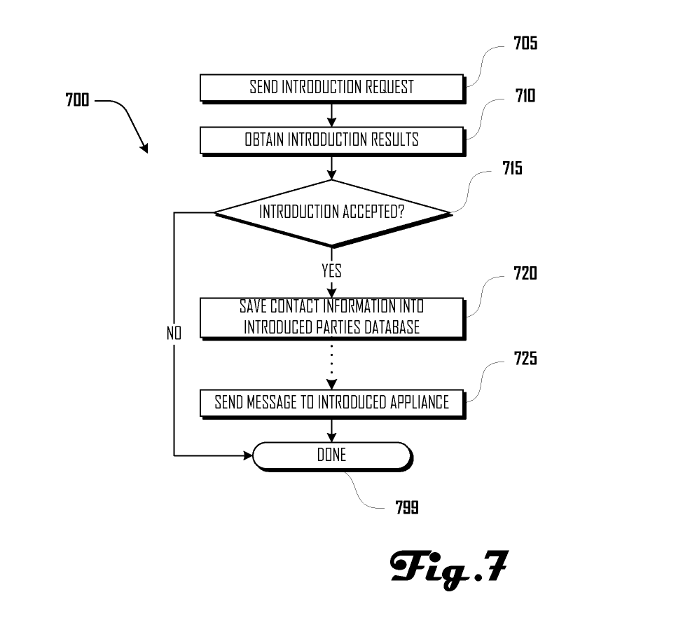

FIGS. 7-9 illustrate exemplary flow diagrams of the processes performed at devices within the system 100 to communicate a secure message.

FIG. 7 illustrates an exemplary flow diagram of an introduced communication routine 700 performed at a requesting appliance to initiate a secure communication with a destination appliance. Introduced communication routine 700 begins at block 705, where an introduction request is sent to a trusted introduction device (e.g., the NSI 200 or the like). The results of the introduction request are obtained in block 710. Next, in decision block 715, a determination is made whether the introduction was accepted. If so, in block 720 the contact information for the destination appliance is saved into the introduced parties database 375. If not, processing would proceed to block 799.

Once the contact information of the destination appliance has been saved, at some future point, as shown in block 725, a message may be sent to the introduced appliance. Routine 700 ends at block 799.

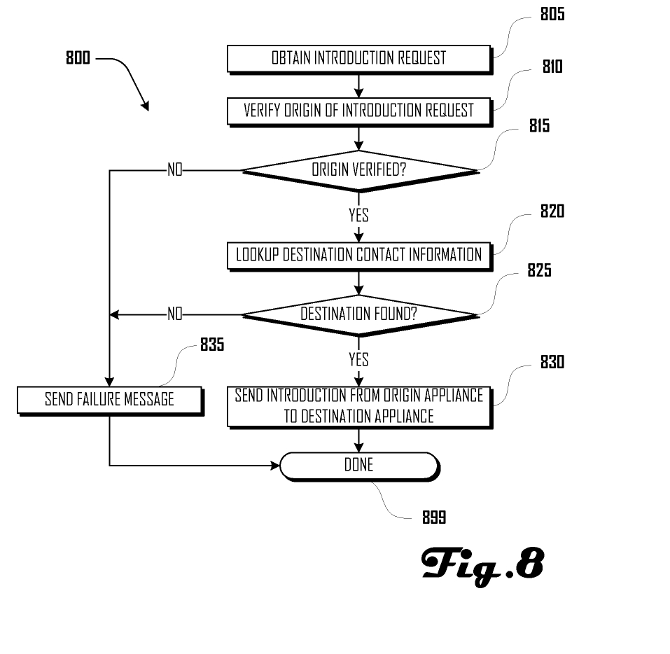

FIG. 8 illustrates an exemplary flow diagram of an introduced communication routine 800 performed at the NSI 200 to facilitate a secure communication with a destination appliance. Introduced communication routine 800 begins at block 805 where an introduction request is obtained. In block 810, the origin of the introduction request is verified (e.g., by checking the registered parties database 270). If the origin is verified, as determined in decision block 815, processing proceeds to block 820, where the destination appliance's contact information is looked up. If the origin was not verified, processing would proceed to block 835, where a failure message would be sent to the requester and routine 800 would end at block 899.

If a destination's contact information was looked up successfully, as determined in decision block 825, processing proceeds to block 830, where an introduction of the requester appliance is sent to the destination appliance and processing proceeds to block 899. If a destination's contact information was not found, as determined in decision block 825, processing would proceed to block 835 as noted above.

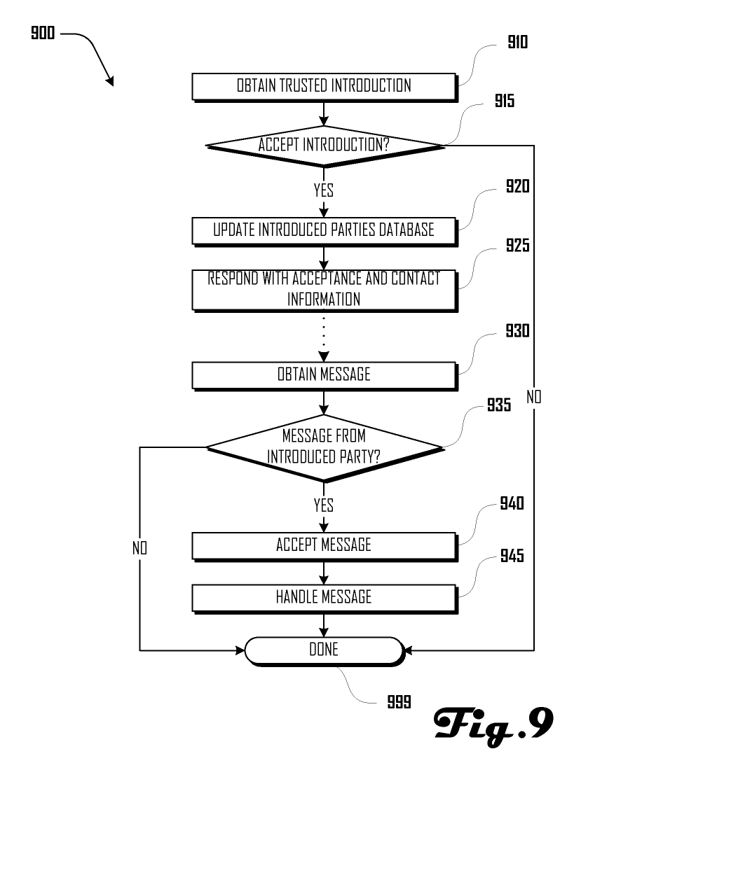

FIG. 9 illustrates an exemplary flow diagram of an introduced communication routine 900 performed at a destination appliance. Routine 900 begins at block 910 where a trusted introduction is obtained (e.g., from NSI 200, or the like). If, as determined in decision block 915, the introduction is accepted, processing proceeds to block 920. Otherwise, processing proceeds to block 999, where routine 900 ends.

In block 920, the introduced parties database 375 is updated with the contact information of the origin appliance requesting the introduction. In block 925, an introduction acceptance is sent to the origin appliance.

At some point, a message may be obtained (e.g., from the introduced origin appliance), as show in block 930. In decision block 935 a determination is made whether the message came from an introduced party (e.g., do they exist in the introduced parties database 375). If the message came from an unknown party, processing would simply proceed to block 999. Otherwise, if the appliance sending the message had been introduced, processing would proceed to block 940, where the message would be accepted. In block 945 the destination appliance would handle the message and processing would end at block 999.

Person To Person Communications:

The inter-appliance communications described above may be leveraged by a secure person-to-person communication infrastructure described below. This exemplary embodiment of person-to-person communications supplements the introduced communications mechanism explained above.

This person-to-person communications may use the Entity Master Index 275 (“EMI”). The EMI 275 enables each Appliance 300A-C to expose to its client devices 110 the list of bona fide providers in the secure communications system 100, in order to enable a client 110 to address a secure message to any client 110 in the secure communications system 100. This enables any authorized user in the system to send a message to any other trusted and advertised provider. Before any entity can receive a secure message from another, information about the identity and location of that entity should be entered in the EMI 275.

The EMI 275, in some embodiments, has two parts: a Global Entity List (“GEL”) and the Location Map (not shown). The GEL (not shown) is a list of all users in the system 100. These correspond to the different trusted persons and other human-addressable entities in the system 100. In some embodiments, entries in the GEL list are created only after extensive verification of the identity and credentials of the person or entity, including reference checks where applicable. This ensures the trustworthiness of the entries in the GEL.

The Location Map contains a mapping of each provider to one or more appliances 300A-C in the secure communications system 100. Given the identity of any entity in the network, this enables any Appliance 300A-C to determine the peer appliance to which secure messages addressed to that entity should be directed.

The Security and Role Repository (not shown) contains the identities of all the end users of the Appliance 300A-C and the roles assigned to them. Additionally, for each end user, it also enables the administrator to assign one or more user identities from the GEL, thus declaring that global entity to be assigned to the local end user.

In order to identify and correlate entity information between different internal systems at the practice, a Cached Entity Master Index (“CEMI”) 385 may be maintained at the appliance 300. The CEMI 385 is a replica of the EMI 275 contents, including the GEL and the Location Map. This is copied periodically to each Appliance 300A-C in order to enable users using the client application to locate and select recipients for the secure messages.

Secure Person-to-Person Messaging:

FIG. 10 depicts how person-to-person secure messaging is performed with a combination of the EMI 275 and secure trusted appliance communications described above.

Replication of the Entity Master Index:

At regular intervals, the Entity master index Propagation service 380 on Appliance A 300A requests 1005 updates to the EMI 275 information. The EMI Provider Service 280 on NSI 200 retrieves 1010 the latest information from the Entity Master Index database 275. The updated EMI information is returned 1015 to Appliance A 300A. The updates to the EMI are saved 1020 in the CEMI 385 by the EMI Propagation Service 380. Such replication of the EMI is optional and may be useful if the client devices 110 need access to the information without having to make a round trip to the original source of information at the NSI 200.

Person/Machine to Person Communication:

The following are exemplary steps that may take place when a client device A 110A connected to appliance A 300A requests to send a secure message to a person registered at a different appliance. A user using Client Device A 110A, requests 1025 a secure message to be sent to another person. Such a request to send a message to another person may not only be performed by a person, but also performed by a program using an application programming interface. The information about the appliance where the recipient entity is present is retrieved 1030 by the Secure Messaging Service 370 from the CEMI 385. Assume the destination user/recipient is registered at appliance B 300B. The secure Messaging Service 370 calls the Communication service 365 to send a secure message to Appliance B 300B. Using the secure introduced communication mechanism, the Communication service 365 on appliance A sends 1035 the message to the Communication service 365 on appliance B 300B. The Communication service 365 on Appliance B 300B passes the message to the secure messaging service 370 on the same appliance. The secure messaging service 370 consults 1040 the CEMI 385 to retrieve the entity at Appliance B 300B who is associated with the person to whom the message is addressed. The secure messaging service 370 places 1045 the secure message in the Message Inbox 390 with the recipient user ID set to the local user to whom the person is mapped. The recipient user, using the client device B 110B, associated with Appliance B 300B, requests 1050 to view the incoming secure messages. The request is sent to the Secure messaging Service 370. Secure messaging service 370 retrieves 1055 the incoming messages from the Message Inbox 390, which includes the new message that has arrived for that user. Secure messaging service 370 returns 1060 the incoming message(s) to client B 110B, where the recipient user receives and views the secure message.

As an alternative, the person sending or receiving a secure message may be replaced by a software program or other device that is designed to do so, on a person's/entity's behalf.

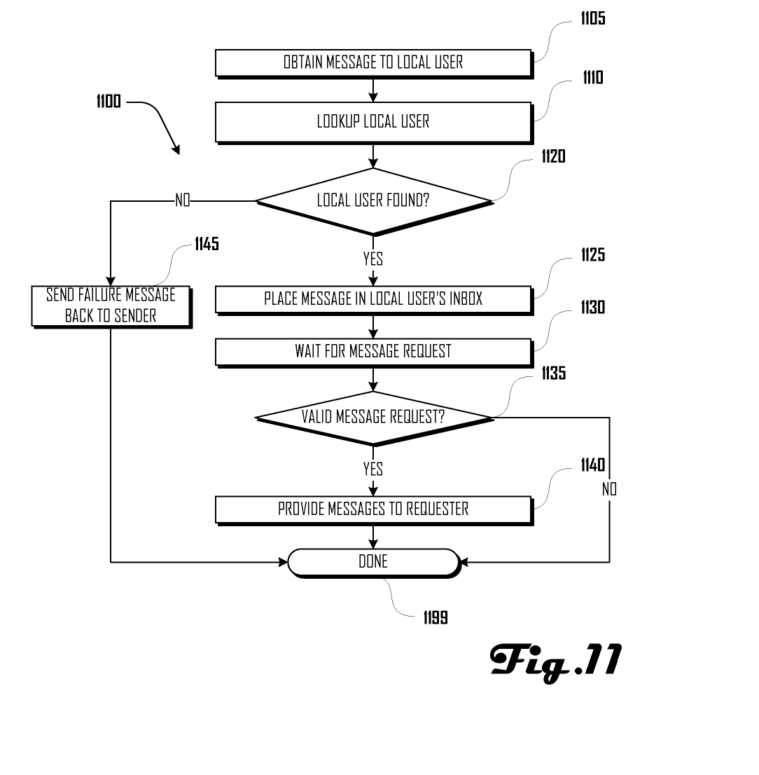

FIG. 11 illustrates an exemplary flow diagram of a person-to-person introduced communication routine 1100 performed at the receiving appliance to facilitate a secure communication to a destination user. Routine 1100 begins at block 1105, where a message to a local user is obtained. In block 1110 the local user is looked up. If, as determined in decision block 1120, the local user is found, processing proceeds to block 1125. Otherwise, a failure message is sent back to the message sender in block 1145 and routine 1100 ends at block 1199.

In block 1120 the message is placed in the user's inbox 390 on the receiving appliance. Routine 1100 waits in block 1130 until a message request is received. Once a valid message request is received, as determined in decision block 1135, the message(s) in the user's inbox 390 are provided to the requester in block 1140. After the messages have been received, or if the message request was invalid, routine 1100 ends at block 1199.

In addition to messages, organizations would like to leverage the ubiquitous and inexpensive Internet for providing services that are commonly used by multiple entities. For example different branches of an organization in the financial services industry may want to use a common set of services for performing financial modeling for customer accounts. In the healthcare industry, two physicians may want to share the same common Data services to convert healthcare information to a common format. Multiple intelligence agencies may want to use a set of shared services to analyze fingerprints to identify matching individuals. In addition to coordinating the communications between different nodes, the NSI 200 may also include a list of registered service providers, such as within a Network Service Registry 292 along with additional information pertaining to each of the services they expose. This additional information may include, but is not limited to, the current utilization of the service, the configuration information about the service, the load being applied on the service and the availability of the service. These attributes of a service provider may be used by a prospective consumer of the service (For example, Appliance B 300B) to determine which service provider in the system 100 should be invoked to perform the specific service it requires. Additionally, the NSI 200 includes a list of patients and the practices where they have been registered. This list of practices and patients is termed the Master Person Index 298 or “MPI”. The MPI 298 is a repository of patients' relevant demographic information which can be used to quickly lookup any patient by the name, social security number or other identifying information. Once a patient is found, the MPI 298 also has the ability to provide information on the different appliances in the network where the patients' data can be found.

In one exemplary embodiment illustrated in FIG. 1, any given set of sites/Appliances A-B 300A-C communicating and collaborating with each other in a peer-to-peer fashion can utilize one of the Service Components (294, 394) to perform transformation of data from a given set of source formats to a given set of destination formats.

Such utilization of shared resources (Data services is an example of such a resource) can be achieved by the nodes (appliances 300 or their clients 110) in the system 100 without regard to the actual location/appliance where these actual services are present and available. In addition, the lack of availability of any of the Data service instances can be accounted for by the system 100 by routing the requests for such services to the ones that are available.

Network Service Registry:

The network service registry 292 is a collection of information about the different services that exist in the entire network. This is kept up-to-date by each service component (294, 394) at regular intervals, to maintain an accurate list of services available and additional information corresponding to each service.

Local Service Registry:

The local service registries 392 are repositories of information about the different services that are available in the respective local appliance or the NSI 200. The local service registry 392 is kept up-to-date by each local service component 394 of the Appliance 300, at regular intervals, to maintain an accurate list of services available and additional information corresponding to each service.

Service Registration:

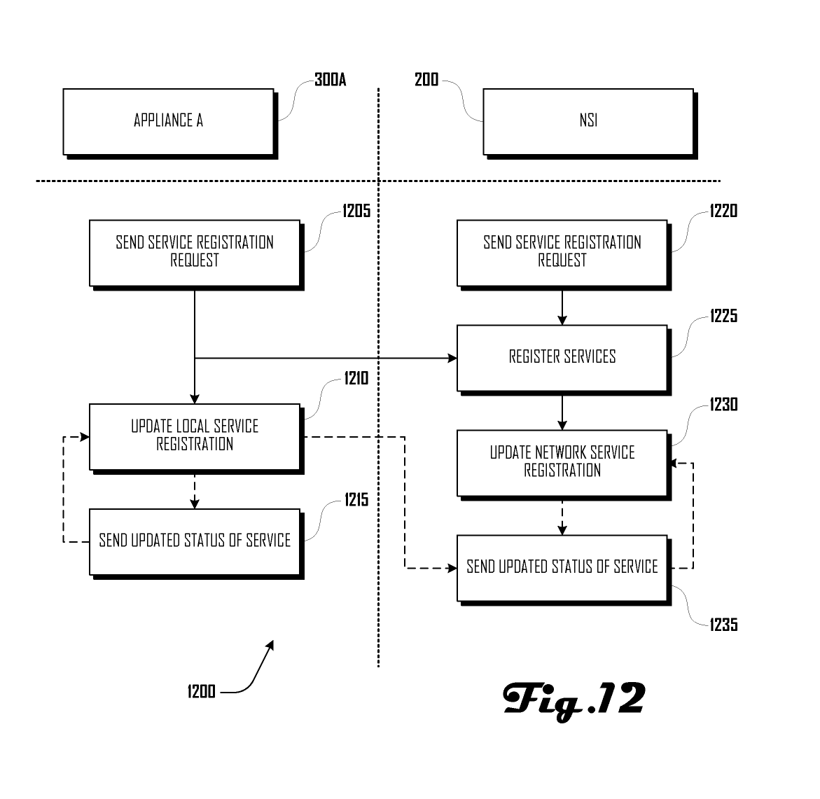

FIG. 12 illustrates an exemplary process of registering a service in the system 100. When the Service components (294, 394) start, each of them sends a request (1205, 1220) to the NSI 200, which in turn registers the services (1225) in the Network Service Registry 292. Service component 394 also updates (1210) the Local Service Registry 392 directly, updating information about itself that only prospective consumers on the local appliance 300A can access. Likewise Network Service component 294 also updates (1230) the Network Service Registry 292 directly, updating information about itself that networked prospective consumers connected to the NSI 200 can access. Once the service registration is performed, each of the service components (294, 394) may be available to accept service requests from any (or a restricted set) of prospective consumers of their services.

At regular intervals, or when specific events occur, each service component (294, 394) may send (1215, 1235) updated status information about themselves to the Local Service Registry 392 as well as the Network Service Registry 292. These specific events may include, but are not limited to, the receipt of a request for processing, the completion of a request, shutting down of the service etc. The additional information sent to the Network Service Registry 292 and the Local Service registry 392 may include but is not restricted to, the number of requests processed by the service, information about the average time the respective service takes to process a request, local resource availability, and the state of the service (Active/Inactive/Paused/Processing are some examples of service state).

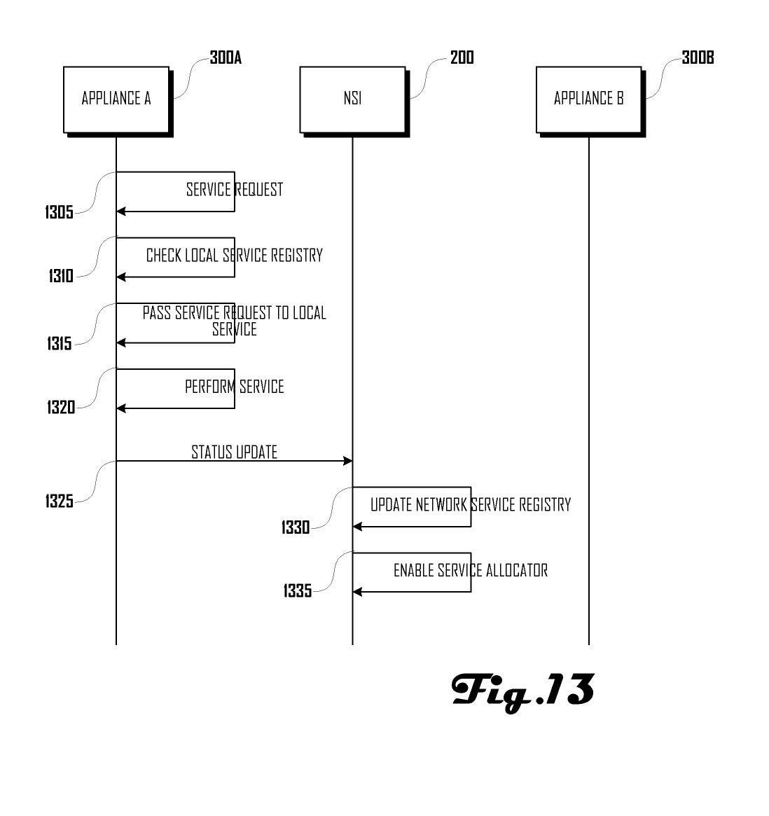

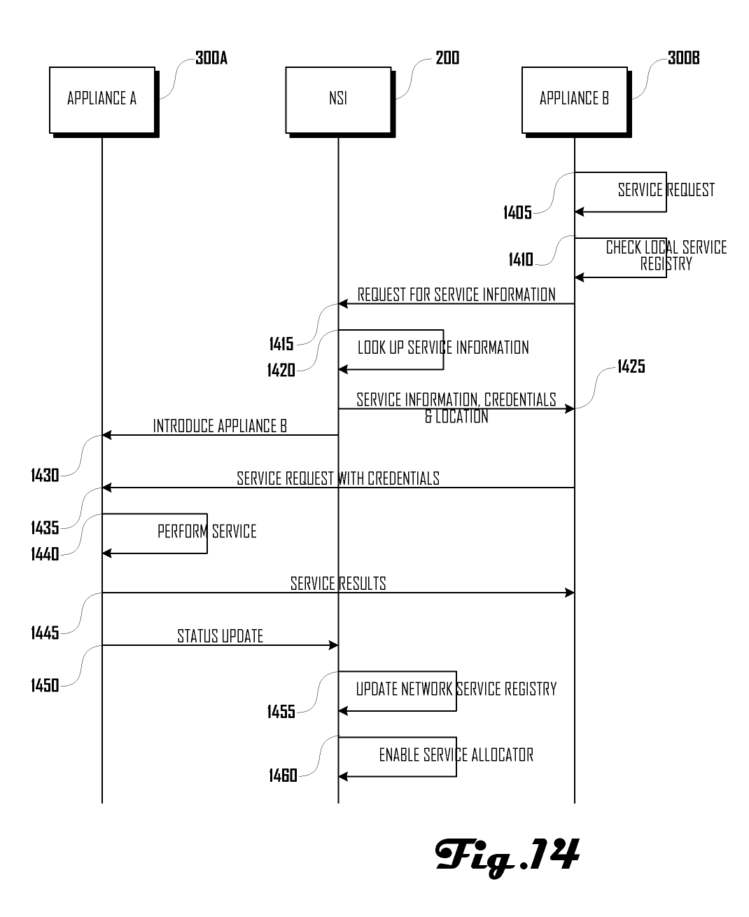

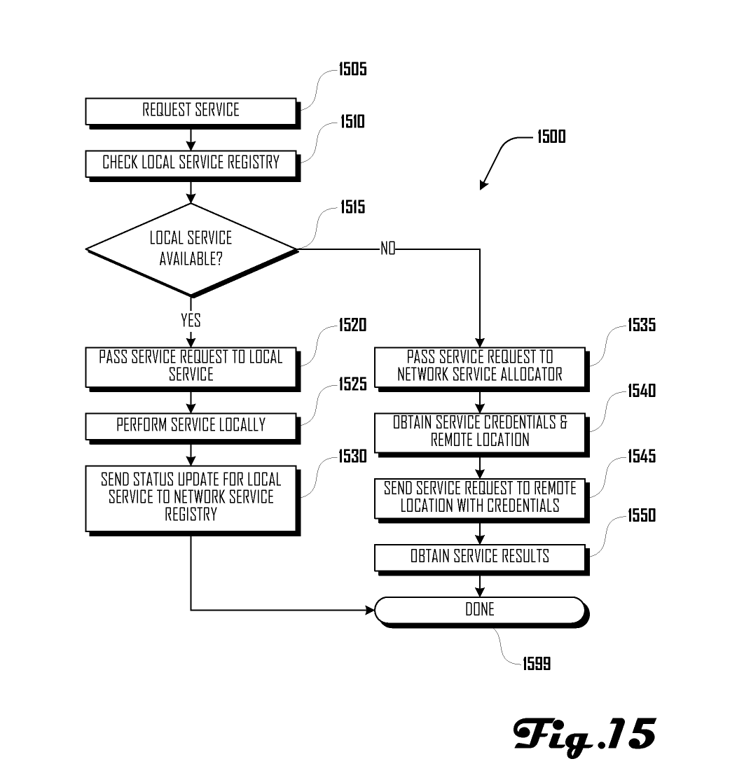

The architecture of example devices that consume Data services are shown in FIGS. 13-14

Processing using a Local Service:

FIG. 13 illustrates processing a local service. When a Client 110 requests to perform a service, it requests 1305 the service. The Appliance A 300A checks 1310 the local service registry 392 to determine that the local system already has a running instance of the Service component 394 that matches the requested service. Next the local service component 394 is passed 1315 the inputs to perform the requested service. The Service Component 394 takes the provided inputs, performs 1320 the requested processing and if the processing is successful, returns the result to the Client 110. If the processing failed for some reason, the error information is returned to the Client 110.

Optionally, once the processing is completed by the Service Component 394, Appliance A 300A may send 1325 an update to the Network Service Registry 292 (and/or the Local service Registry 392) with information such as current load on the service component 394, the number of requests processed and the availability or status. Such updates may be optional, and the service may perform these updates at regular intervals, after processing each request, after processing a number of requests, or never at all. When such an update is received by the NSI 200, it updates 1330 the information about the service into the Network Service Registry 292, which subsequently may enable 1335 the Service Allocator 296 to make allocation decisions with the most current information.

Processing using a Remote Service:

FIG. 14 illustrates processing a local service. When a Client 110 of Appliance B 300B which does not have a local service available requires a service, it may make a request 1405 on the local appliance, Appliance B 300B for the service. The Appliance B 300B makes a decision of which actual instance of Service in the system 100 the request will be routed to and processed by. While it does not necessarily perform the requested service, it may hold the responsibility of first determining the location of correct service to use, and forwarding the request to an appropriate service implementation at the chosen location. It may also be responsible for receiving the result of the processing and passing it back to the entity that requested the service.

The example of FIG. 14 shows the sequence of events that happen when a Client 110 requests a service and Appliance B 300B does not have the service available (e.g., there is no instance of the desired service component 394 on Appliance B 300B). Additionally, this example illustrates the case when the Service Allocator 296 determines that the Service Component 394 on Appliance A 300A is the optimal service component 394 to use. A similar sequence of events may occur if the service is performed by a Service Component 294 hosted on the NSI 200.

When a Client 110 of Appliance B 300B requests 1405 to perform a service, Appliance B 300B determines, by checking 1410 in the Local Service Registry 392) that there is no available service on Appliance B 300B. This causes Appliance B 300B to contact 1415 the Service Allocator 296 component in the NSI 200, with a request to provide information on the most appropriate service component to use. The Service Allocator 296 receives the request, the parameters of which may include, but are not limited to those that describe the type of service requested, the amount of data that needs to be passed to the service and the location from where the call originated. With these parameters, it looks up 1420 in the Network Service Registry 292 to determine the most appropriate service to use. This determination may be based on various factors including, but not limited to, the type of service requested, the desired configuration of service instance, availability of the service instance, proximity to the requesting service, number of outstanding requests to the service instance, average turn-around times for the service instance. Based on one or more of the actual factors used in the selection, the Service Allocator 296 returns 1425 to Appliance B 300B, the location and credentials of the selected service to be used, along with an optional count of the number of requests that may be forwarded to the selected Service Instance. This is to avoid Appliance B 300B from having to contact the Service Allocator 296 too frequently for each request it needs to process. The Service Allocator 296 may additionally perform an introduction 1430 of the requesting appliance (Appliance B 300B) to the appliance on which the service instance is running (Appliance A 300A).

When Appliance B 300B receives the address and credentials for the selected service (assume Service Component 394 on Appliance A 300A is selected) from the Service Allocator 296, Appliance B 300B may send 1435 the service request in a secure and trusted manner to the corresponding Service Component 394 at the destination appliance (Appliance A 300A). The Service Component 394, in turn performs the service 1440, and returns 1445 the results on successful completion or error information on a failure back to Appliance B 300B.

Optionally, once the processing is completed by the Service Component 394, Appliance A 300A may send 1450 an update to the Network Service Registry 292 (and/or the Local service Registry 392) with information such as current load on the service component 394, the number of requests processed and the availability or status. Such updates may be optional, and the service may perform these updates at regular intervals, after processing each request, after processing a number of requests, or never at all. When such an update is received by the NSI 200, it updates 1455 the information about the service into the Network Service Registry 292, which subsequently may enable 1460 the Service Allocator 296 to make allocation decisions with the most current information.

In some embodiments, when any Appliance 300A-C detects a failure or a “resetting” event for itself, such as being restarted, having the Internet address changed, or the like, it performs a registration (see FIG. 12) of all the locally available services (Example: Service Component 394) on the NSI 200. This updates the Network Service Registry 292 on the NSI 200 with the current information needed by other appliances to discover the registered service.

FIG. 1 shows the different clinical devices that come into play in an exemplary clinical scenario utilizing the invention. Each of the appliance 300A-C are potential locations where patients may be registered from and documents such as Consult Reports, medication information, Clinical Notes and the like may be generated for any of the registered patients. The NSI 200 may include the MPI 298, an optional central document store 299 and an optional central document store 299. The central document store 299 is optional in the sense that the invention may fulfill its purpose without the necessity to have a central repository. The presence of a central repository however may enhance the functionality of the system by providing an additional safeguard to the entire system.

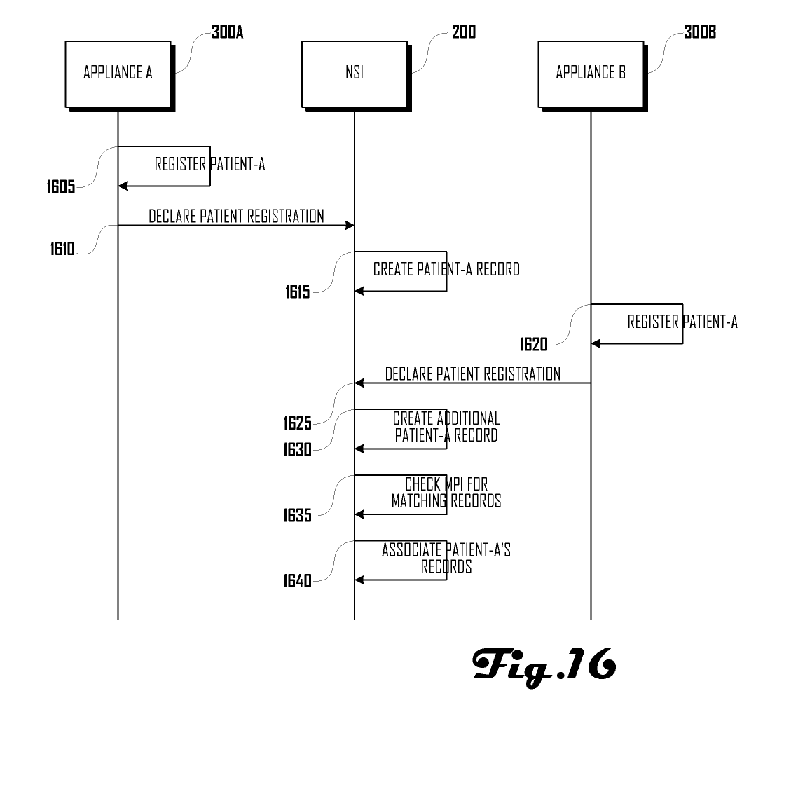

FIG. 16 shows the process by which the same patient PATIENT-A is registered at different practices (appliances). When the patient is registered 1605 at the practice of Appliance A 300A, Appliance A 300A declares 1610 the registration to the NSI 200. The NSI 200 creates 1615 a patient record in the MPI 298 with information about the registered patient, along with the fact that the particular patient information was received from Appliance A 300A.

When the same patient PATIENT-A is registered 1620 at a Physician Practice associated with Appliance B 300B, Appliance B 300B declares 1625 the registration to the NSI 200. The NSI 200 creates 1630 a record in the MPI 298 with information about the new patient registration. The NSI checks 1635 in the MPI 298 and finds that records 304 also corresponds to the same patient and associates 1640 them together in the MPI 298 database

In addition to storing demographic information about the patient, the MPI 298 also stores a reference to the Appliance 300A-C from which the patient registration request originated. This means for any individual patient in the network, at any future point of time, the MPI 298 can provide a list of different practices/hospitals that have registered the same patient. In one embodiment, all such practices are assumed to be treating the individual patient. This list of practices in the MPI 298 for each patient may be utilized by the network when a new document is generated for the patient at any practice to determine which other practices in the network are associated with the patient.

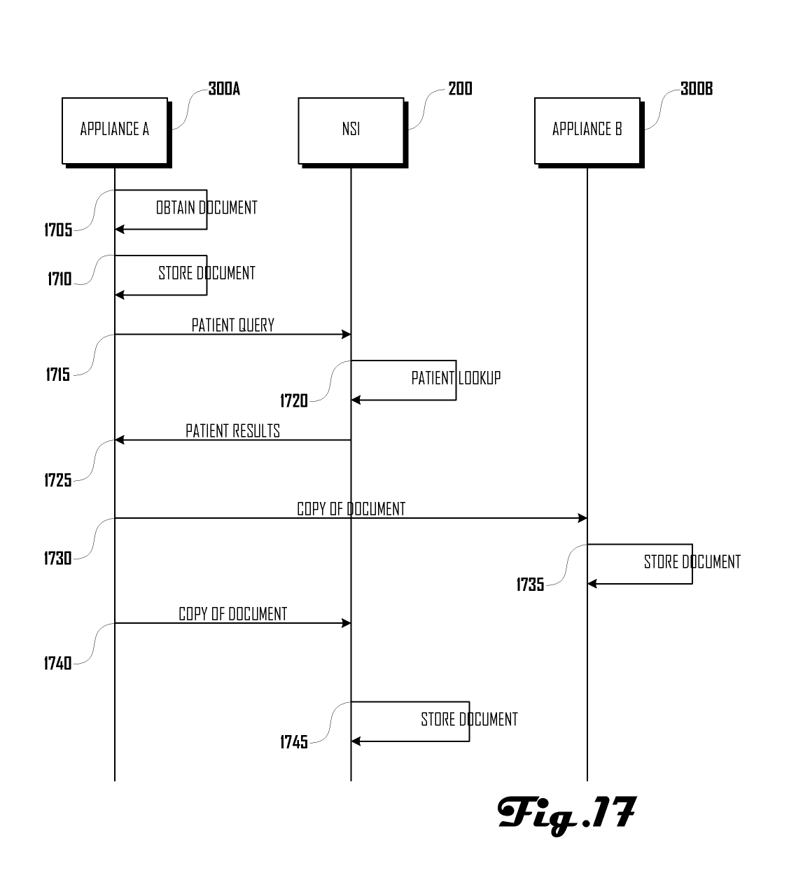

FIG. 17 shows the process that occurs when a new document (For example, a Consult Report) is obtained 1705 for PATIENT-A at Appliance A 300A. Appliance A 300A stores 1710 the newly generated document in its local document store 399. After the document has been saved in the local document store 399, Appliance A 300A then queries 1715 the NSI 200 to determine the other practices in the network that are treating the same individual patient. The NSI 200 then looks up 1720 the patient in the MPI 298 and passes 1725 the results back to Appliance A 300A. Appliance A 300A is able to determine that the Physician Practice associated with Appliance B 300B is also involved in treating PATIENT-A. Appliance A 300A sends 1730 a copy of the original document to Appliance B 300B. Appliance B 300B stores the Document Copy to its Document Store 399.

Optionally, Appliance A 300A may also send 1740 a copy of the original document to the NSI 200 with a copy of the original document. In this event, NSI 200 with save 1745 the Document Copy to the Document Store 299. In some embodiments, documents are sent to the Document Store 299 in the NSI 200 when the network 100 is not found to have a minimum number of practices where the patient in question (PATIENT-A) is registered. This is to ensure that there are sufficient reliable sources of data should any of the individual locations of care be unavailable. Once the patient is detected to be registered at more than the required minimum, such propagation of data to the Document Store 299 in NSI 200 may be stopped.

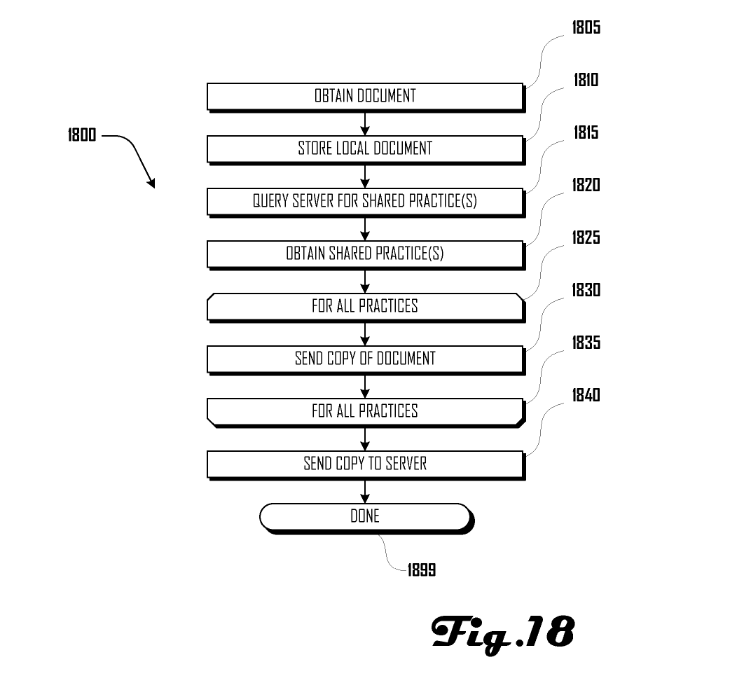

FIG. 18 is a representative flow diagram of a document handling routine 1800 for distributing a document to appropriate locations in the redundant data storage system 100. Document handling routine 1800 begins at block 1805 where a document is obtained. In block 1810 the document is stored in the document store 399. The NSI 200 is queried in block 1815 for the location of practices that share the document's patient. From the results obtained in block 1820, looping block 1825 begins iterating through each shared practice location. Block 1830 sends a copy of the document to an associated device (e.g., appliance 300) of the current practice. Looping block 1835 cycles back to looping block 1825 until all practices have been iterated through. Optionally, a copy of the document may be sent to the NSI 200 for storage in its document store 299 as shown in block 1840. Document handling routine 1800 ends at block 1899.

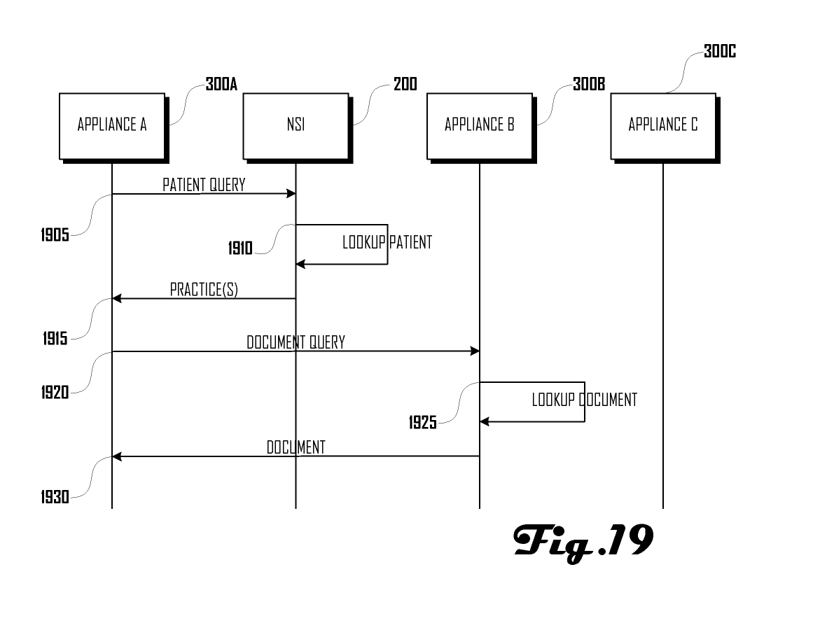

FIG. 19 depicts the process by which Appliance A 300A retrieves the document that was generated at Appliance B 300B (or some other appliance) related to PATIENT-A from the Appliance B 300B, with the precondition that Appliance B 300B is accessible from Appliance A 300A.

When a user at Appliance A 300A requests for a document for PATIENTA that was generated at Appliance B 300B, Appliance A 300A queries 1905 the NSI 200 to determine the list of practices where PATIENT-A is registered and thus documents may be found. The NSI 200 consults 1910 the MPI 298 to retrieve the list of practices. In this specific example, the records are found to exist, signifying that Appliance B 300B has PATIENT-A registered. This information is passed 1915 back to Appliance A 300A. Appliance A 300A next performs a query 1920 to Appliance B 300B for the required document. Appliance B 300B looks up 1925 in the document store 399 to retrieve the document. Appliance B 300B returns 1930 the document to the Appliance A 300A. The Appliance A 300A may then return (not shown) the document to the user that performed the search.

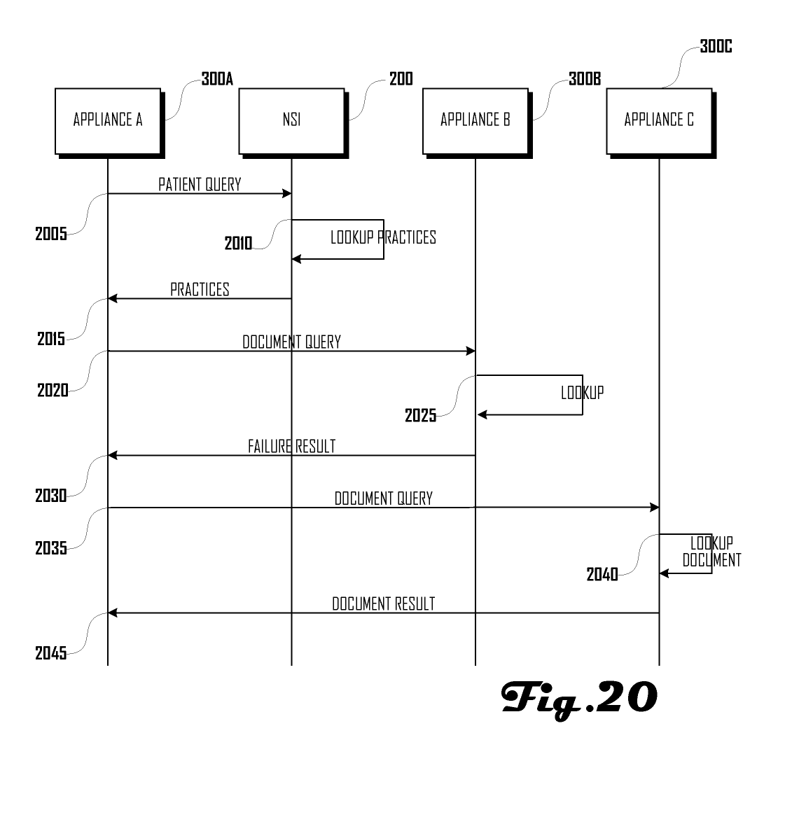

FIG. 20 depicts the process by which Appliance A 300A retrieves the document that was generated at Appliance B 300B (or some other appliance) related to PATIENT-A from the Appliance B 300B, with the precondition that Appliance B 300B is inaccessible from Appliance A 300A or no longer has the required document.

When a user at Appliance A 300A requests for a document for PATIENTA that was generated at Appliance B 300B, Appliance A 300A queries 2005 the NSI 200 to determine the list of practices where PATIENT-A is registered and thus documents may be found. The NSI 200 consults 2010 the MPI 298 to retrieve the list of practices. In this specific example, the records are found to exist, signifying that Appliance B 300B has PATIENT-A registered. This information is passed 2015 back to Appliance A 300A. Appliance A 300A next performs a query 2020 to Appliance B 300B for the required document. Appliance B 300B looks up 2025 in the document store 399 to retrieve the document. Appliance B 300B returns 2030 a failure result to Appliance A 300A. Accordingly, Appliance A 300A next performs a query 2035 to Appliance C 300C (which was listed in the list of practices received from the NSI 200 that have the document) for the required document. Appliance C 300C looks up 2040 in the document store 399 to retrieve the document. Appliance C 300C returns 2045 the document to Appliance A 300A. Appliance A 300A may then return (not shown) the document to the user that performed the search.

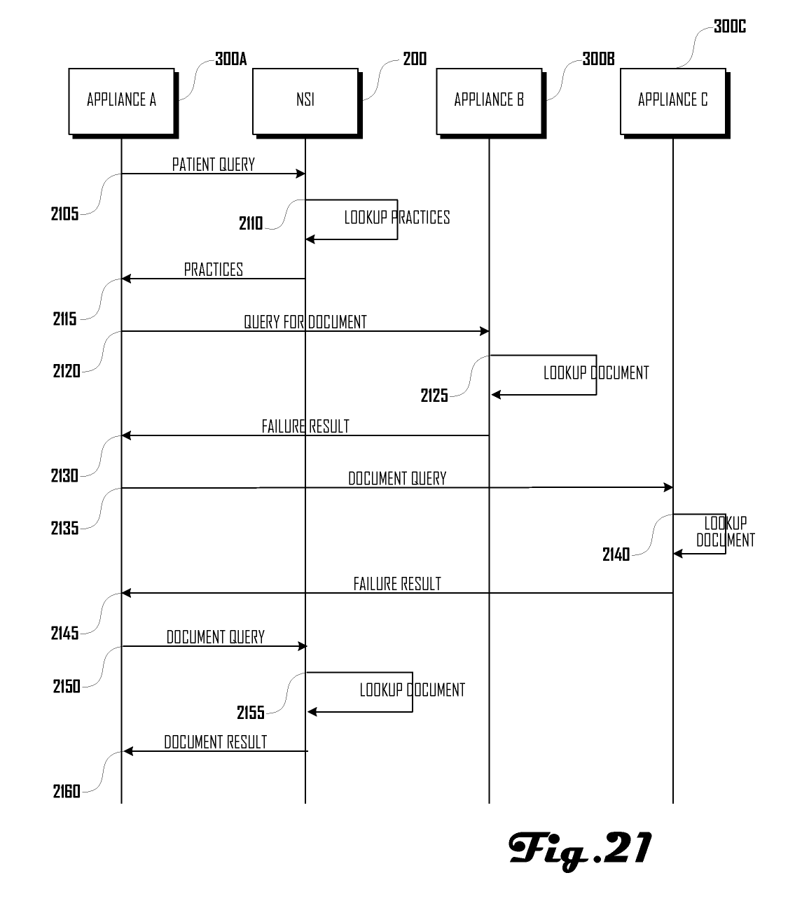

FIG. 21 depicts the process by which Appliance A 300A retrieves the document that was generated at Appliance B 300B (or some other appliance) related to PATIENT-A from the NSI 200, with the precondition that designated appliances are inaccessible from Appliance A 300A or no longer have the required document.

When a user at Appliance A 300A requests for a document for PATIENTA that was generated at Appliance B 300B, Appliance A 300A queries 2105 the NSI 200 to determine the list of practices where PATIENT-A is registered and thus documents may be found. The NSI 200 consults 2110 the MPI 298 to retrieve the list of practices. In this specific example, the records are found to exist, signifying that Appliance B 300B has PATIENT-A registered. This information is passed 2115 back to Appliance A 300A. Appliance A 300A next performs a query 2120 to Appliance B 300B for the required document. Appliance B 300B looks up 2125 in the document store 399 to retrieve the document. Appliance B 300B returns 2130 a failure result to Appliance A 300A. Accordingly, Appliance A 300A next performs a query 2135 to Appliance C 300C (which was listed in the list of practices received from the NSI 200 that have the document) for the required document. Appliance C 300C optionally looks up 2140 in the document store 399 to retrieve the document. Appliance C 300C also returns 2145 a failure result to Appliance A 300A. Appliance A 300A next performs a query 2150 to the NSI for the same data. When the NSI 200 receives a request for a document generated at an appliance (e.g., Appliance B 300B) for PATIENT-A, it looks up 2155 in the Document store 299, and finds that a copy of the document, exits. The NSI 200 returns 2160 this copy to Appliance A 300A. Appliance A 300A may then return (not shown) the document to the user that performed the search.

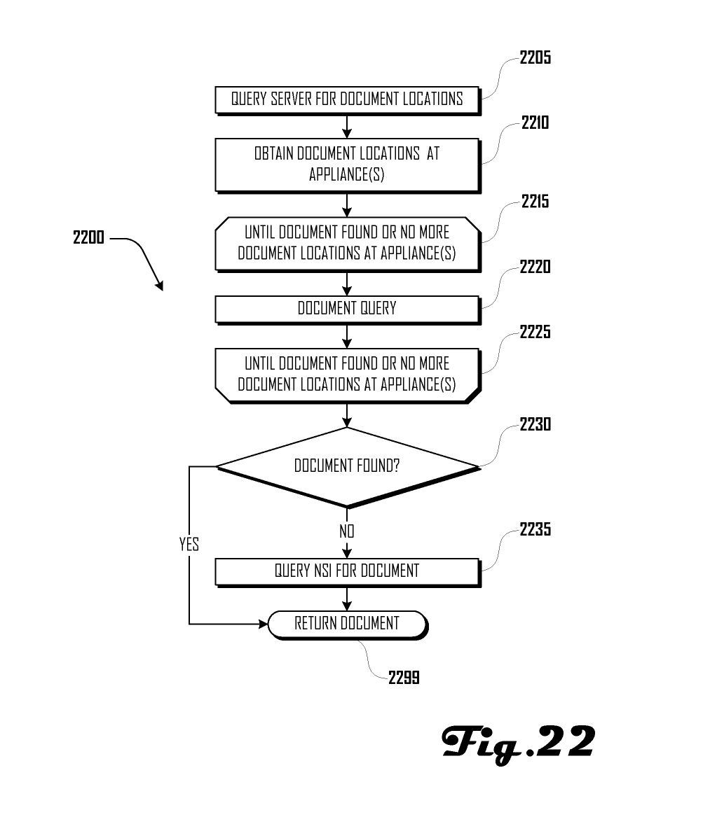

FIG. 22 illustrated an exemplary document retrieval subroutine 2200. Subroutine 220 begins at block 2205 where the NSI 200 is queried for document locations. The document locations are obtained in block 2210 from the NSI 200. Next, looping block 2215 begins an iteration for each location where the document can be found (until all have been checked, or the document is found). Block 2220 queries the current location for a copy of the document. Looping block 2225 cycles back to looping block 2215 until all locations have been checked, or the document is found, after which, processing proceeds to decision block 2230. If, in decision block 2230 it is determined that the document was found, the document is retuned to its calling routine in block 2299. If, however, the document was not found, processing proceed from decision block 2230 to block 2235 where the NSI 200 is queried for the document, which is then returned to the calling routine in block 2299.

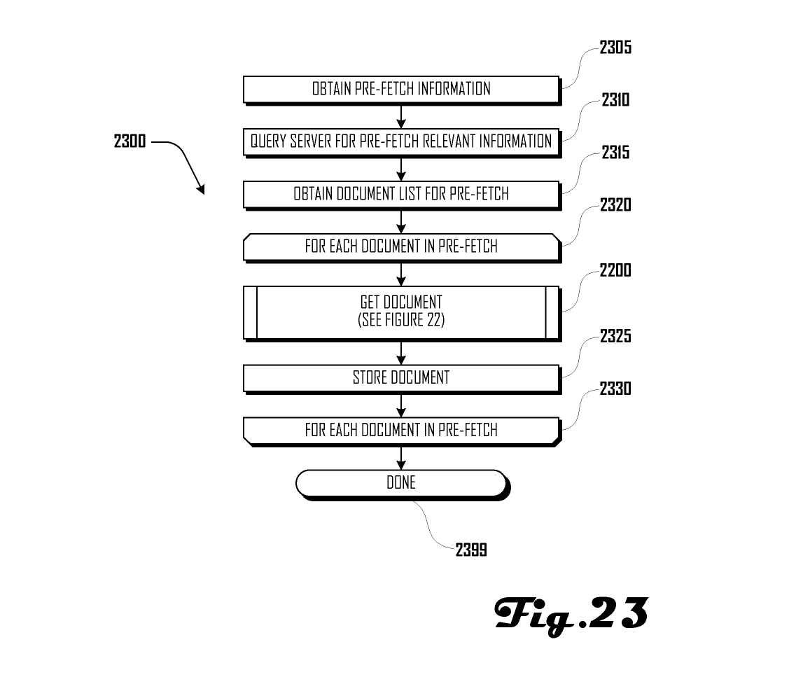

FIG. 23 depicts the process by which an Appliance 300 anticipates the need to retrieve a patient's documents before the actual document retrieval is performed. Appliance 300 may predict the need for such a retrieval under various circumstances, including, but not limited to the following: Patient calls the practice to schedule an appointment for a later date; patient reports at a practice and registers himself/herself. In both these cases and in other ones, the retrieval of the actual clinical documents pertaining to the patient is not performed until some time later, for example, when a physician actually tries to investigate the patient's clinical background. Pre-fetching the clinical information documents from other practices has the benefit of reducing the time the requester of the information has to wait while the documents are fetched from other practices. It also reduces the chances of failure at the time of actual request due to events such as network failures at the time of actual request, since all relevant documents may already be present at the local practice.

When an event at Practice signifies the anticipation of the need to retrieve Patient A's documents from the network predictively (2305), the Appliance A 300A makes a request (2310) to the NSI 200 for a list of all other practices where the same patient's information may be found. The NSI 200 the MPI 298 and finds the relevant records of the patient registration registered practices (e.g., appliances 300). For each document identified (2315), the documents are prefetched using document retrieval subroutine 2200. In prefetch routine 2300, looping block 2320 begins iterating through each document. In subroutine block 2200 (illustrated in FIG. 22 and described above), the document is retrieved. In block 2325 the current document is stored to the document store 399. Next, looping block 2330 cycles back to looping block 2320 until all documents have been iterated through, after which routine 2300 ends at block 2399.

Later, when a user at Appliance 300 requests for documents for Patient-A, the request may be satisfied by simply querying the Document store 399 rather than having to perform a search across the network. In addition to this, the Appliance A 300A may also query the Document Store 299 in the NSI 200 in the event that any peer practice that is known to hold information about Patient-A is inaccessible or unable to return the requested documents.

Note that in addition to the scenarios when a practice requests data generated at another practice, this invention may also be used in cases when a practice needs to be rebuilt after a catastrophic failure. In such a case, the above processes will be followed by a practice that will be requesting for data generated from itself and fetching them from other available sources and using them to rebuild its own document repository.

The Appliance 300 is deployed in each organization. The Appliance 300 may have two sides. An inward facing side and an outward facing side.

The inward facing side of the Appliance 300 may have systems that are within the organization which the Appliance 300 represents. The outward facing side represents other organizations' Appliances.

Privacy rules are rules that control the following aspects of a data exchange between an Appliance 300 and an internal or external system. These rules have the following dimensions.
Document Type: This is the aspect of the rule that specifies what type of document the rule refers to. Examples of different documents include “Patient Demographics data”, “Patient medication order”, “Lab result document”, “Patient Discharge Summary” etc.
Document Content Sensitivity: This is the aspect of the rule that specifies the sensitivity of the content of the document. This is organized into different categories, some of which are: “Normal”, “Normal, private”, “AIDS or HIV related information”, “Mental Health related information”, “sexual abuse related information” etc.
Party: Privacy rules are specified at the Appliance 300 which represents the broker for the exchange. In various embodiments, privacy rules may be specified on the Appliance 300 regardless of whether the document exchange is happening at the inner interface or at the outer interface, and regardless of the direction in which the exchange happens. Hence, rather than call out source party and destination party, we talk about the concept of a party as a system with which the Appliance 300 exchanges data. This can be an internal system, an external system including another instance of the same type of Appliance 300.
Direction: this represents the direction of communication, and can be inbound or outbound. This is always talked about from the point of view of the Appliance 300 which we are interested in.

Some examples of where communication rules can be applied are shown below.

TABLE 1

| Document Type | Sensitivity | Party | Direction |
|---|---|---|---|
| Demographic | Normal | Hospital Admissions | Inbound |
| Information | | System | |
| Demographic | Normal | External Clinic A | Outbound |
| Information | | | |
| Demographic | Normal | External Clinic B | Outbound |
| Information | | | |
| Medication | Normal | Electronic Medical | Inbound |
| | | Records System | |
| Medication | Normal | Any Internal System | Outbound |
| Progress Note | Mental health | Any External Clinic | Outbound |

A rule can be asserted at each one of the instances such as above, which would be applied by the Appliance 300 prior to sending the document (if outbound) or receiving the document (if inbound).

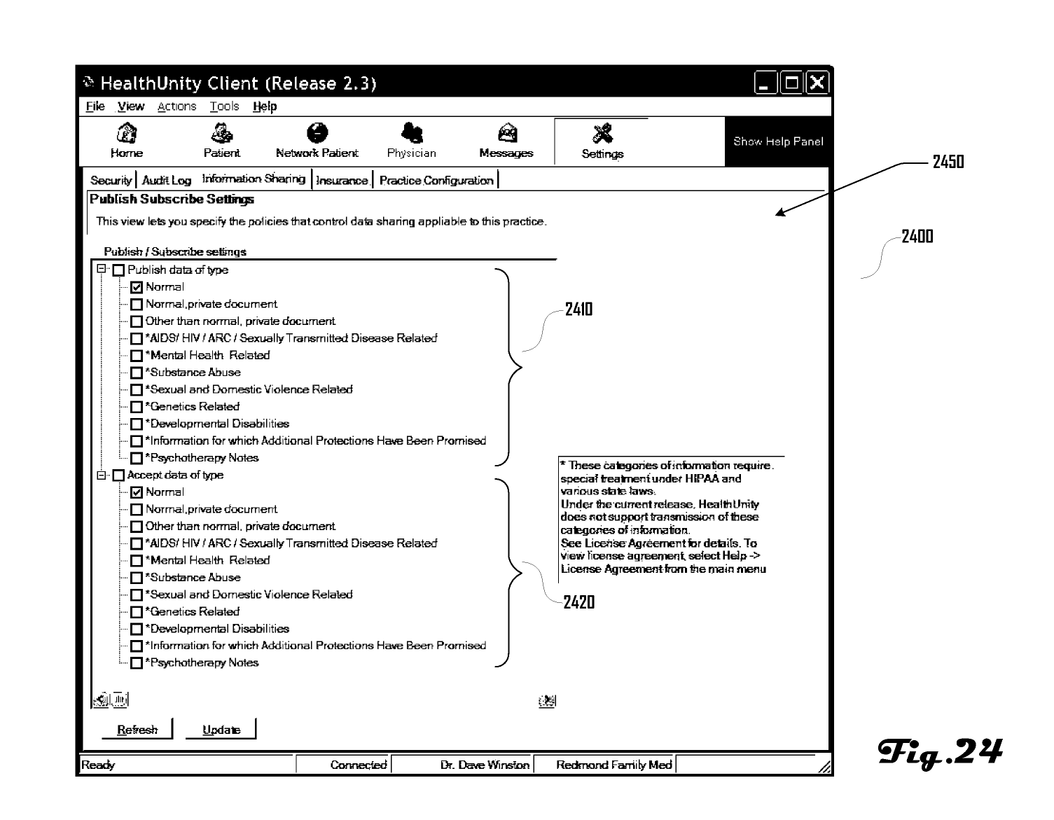

In addition to the information sharing described above, various embodiments limit and/or control how information is or is not shared. FIG. 24, depicts an exemplary user interface (“UI”) 2400 for controlling a practice's data sharing rules 2410, 2420. In the example UI 2400, practice area 2450 has publishing rules 2410 and subscription rules 2420 that indicate practice-wide settings of how outgoing and incoming information should be categorized and controlled.

In FIG. 24, only “normal” is selected from amongst the publishing rules 2410. Accordingly, all published documents from the exemplary practice will have at most a “normal” categorization. In some embodiments, “normal” may be the least restrictive categorization. However, in other embodiments, “normal” may be more restrictive. For example, in a specialized genetics laboratory practice, a “normal” setting may cause more restrictions than a “genetics related” categorization because the specialized practice may be set up to share that information. However, in the scenario described in FIG. 24, “genetics related” data is actually called out as having higher safeguards due to regulatory restrictions (i.e., HIPAA and state regulation).

Also shown in the UI 2400 are subscription rules 2420, which lay out a practice's preferences with regard to accepting data from other practices. In order for a piece of data to be shared between two practices, both the outgoing and incoming controls need to match.

For example, if applicance 300A is a hospital that had an outgoing practice rule set as “normal” for its documents, and if appliance 300B is a physician practice that has a subscription (or inbound) rule set to “normal” then both could share the document with each other. If, however, the physician practice had set its outgoing rule to “other than normal, private document,” then it would not share documents with the hospital. Even if “other than normal, private document” was checked, if the hospital did not have “other than normal, private document” selected as one of its subscription rules, the document would not be received at the hospital.

In addition to practice rules, various embodiments may have patient and/or data specific rules. For example, each of the same rules 2410, 2420 may be employed when categorizing data about a specific patient, or a specific piece of data about a patient. Accordingly, if all rules for a data item, a patient, and a practice in both the outgoing and incoming directions are in correspondence (e.g., all set to “normal”) then data may be shared. If, on the other hand, even a single rule is disjoint, then information is not shared.

For example, appliance 300A belongs to a physician practice and appliance 300B belongs to a hospital. The hospital has a patient for which they have just generated a document relating to a mental health issue. The outgoing rules for the hospital all are set to allow “mental health related” data to be shared. However, the physician practice may have set the specific patient as only to receive “normal” data and did not select “mental health related” data. Even if the physician practice had indicated that they could receive “mental health related” data, the specific patient's record would not be updated at the physician practice because “mental health related” would not be allowed for that patient.

In the absence of any specific patient level rules for publishing or receiving information, it may also be beneficial to enforce separate default rules for normal as well as VIP patients in a practice. Such default settings come into play when a patient does not have a custom rule defined. This provides higher flexibility for supporting scenarios such as an “Opt-Out” rule where all patient by default are opted out of the network until they explicitly “Opt-in” to share information.

Specification of default patient or default VIP settings also enables a practice to quickly and effectively make changes to its own internal policies for information exchange globally for all patients without having to tweak each patients information sharing settings individually. If a patient is determined to be a VIP patient, a different set of rules may be applied depending on the policies adopted by the organization.

In one specific implementation, a determination of whether data may be communicated between two entities in the STN 150 is determined by a process analogous to logically “ANDing” all of the outgoing and incoming conditions for a transmission. Therefore, as seen in the mental health data example above, one condition was “false”; therefore a determination of whether to send any information would also be “false”.

The above discussion relates to how the control of data sharing applies to the way an appliance 300 may be configured to control data exchange globally. The same types of controls may be applied at a patient level where a similar set of configurations and rules may be specified at a patient level. One difference is that the patient settings typically will not require transformations (see below).

When a document is received by the inner or outer interfaces, it first checks to see what the practice Rules evaluate to: Accept/Reject/Transform. Then look to see what the patient's rules evaluate to: Accept/Reject.

The following table illustrates example permissible action to perform for each combination of the rules results.

TABLE 2

| Practice Rule | Patient Rule | Actual action |
|---|---|---|
| Allow | Allow | Allow |
| Allow | Refuse | Refuse |
| Refuse | Allow | Refuse |
| Refuse | Refuse | Refuse |
| Allow w/Transform | Allow | Allow w/Transform |
| Allow w/Transform | Refuse | Refuse |

Example rules may determine one of three things when a document exchange depends on the rule.
(1) Refuse: In this case, the document should not pass through the interface.
(2) Allow: In this case, the document should be allowed to pass.
(3) Allow with transformation: In this case, the document should be allowed to pass after going through a specified type of configurable transformation. One example of such a transformation includes that for de-identifying information when sending the document to an external Appliance 300 which performs public-health monitoring functions, such as disease monitoring, bio surveillance alerting and the like.

Following are some examples of application of the above rules in selected contexts.

Inbound Document restriction

In this scenario,
a document D1 originates from System S1
It is a demographic document, and is associated with the “normal” flag.
The document reaches the inner interface
The inner interface looks up to see if there is any rule setup for this type of document/sensitivity combination inbound from System A
If a rule is found, it is applied and the resultant action is taken.
A rule is found for this combination, and the rule states Allow
The document it allowed to pass into the Appliance 300.

Outbound Document Restriction

In this scenario,
Appliance 300 decides to send Progress Note document to External
Party Practice A
Progress Note is marked as “HIV related”
The document reaches the outer interface on the way out.
The outer interface looks up to see if there is a rule setup for this type of document/sensitivity combination outbound to Practice A
The rule is found, and it states “Refuse”
The document is not allowed to go out to Practice A

In some embodiments, practices, patients and/or documents may be so sensitive that they are completely opted out of the network for data sharing. Simply by selecting an “do not share” option (not shown) a patient's data may be kept entirely local to a practice where the data was originated. Functionally, this would be the equivalent of logically “ANDing” any sharing conditions with a “false”. Another analogy to draw would be that each permissive rule acts as an open gate in a channel of communication between practices. However, a single closed gate will prevent the flow of information. However, an opt-out might eliminate the communication channel altogether.

In some embodiments, practices may have more than one communication rule set for communications with other practices, or with different types of practices. For example, some communications may be permitted between multiple practices once data has been removed of all personally identifiable information. This type of anonymous data sharing may be desirable when tracking communicable diseases. By tracking locations and symptoms it may be possible to determine the existence of an epidemic. However, at least in the monitoring phase, it may not be necessary for a monitoring agency (special practice in the network) to have full personally identifiable data.

Additionally, laboratories may behave differently than other practices in that major laboratories may serve multiple regions and may be part of multiple networks. Managing practices that are connected to more than a single network may employ network-specific controls to ensure that data that is specific to one network is not propagated into other networks (even if a patient is visiting a practice in both separate networks). For example, in one embodiment, a practice, a patient and a data record would all have to explicitly allow for sharing between networks before the data record in question would be sent to another network. Similarly, a receiving practice, and their patient should have subscription permissions turned on. However, in some embodiments, inter-network permissions may be turned on by default.

In some embodiments, a practice (and possibly patients) may have separate communication rule sets based on the type of practice determined to be on the other side of a communication, e.g., laboratory, health monitoring agency, hospital, clinic, dental office, pharmacy and the like. Accordingly, in some embodiments, before information is shared, the type of entity that information may be shared with is verified from a central source, such as the NSI 200.

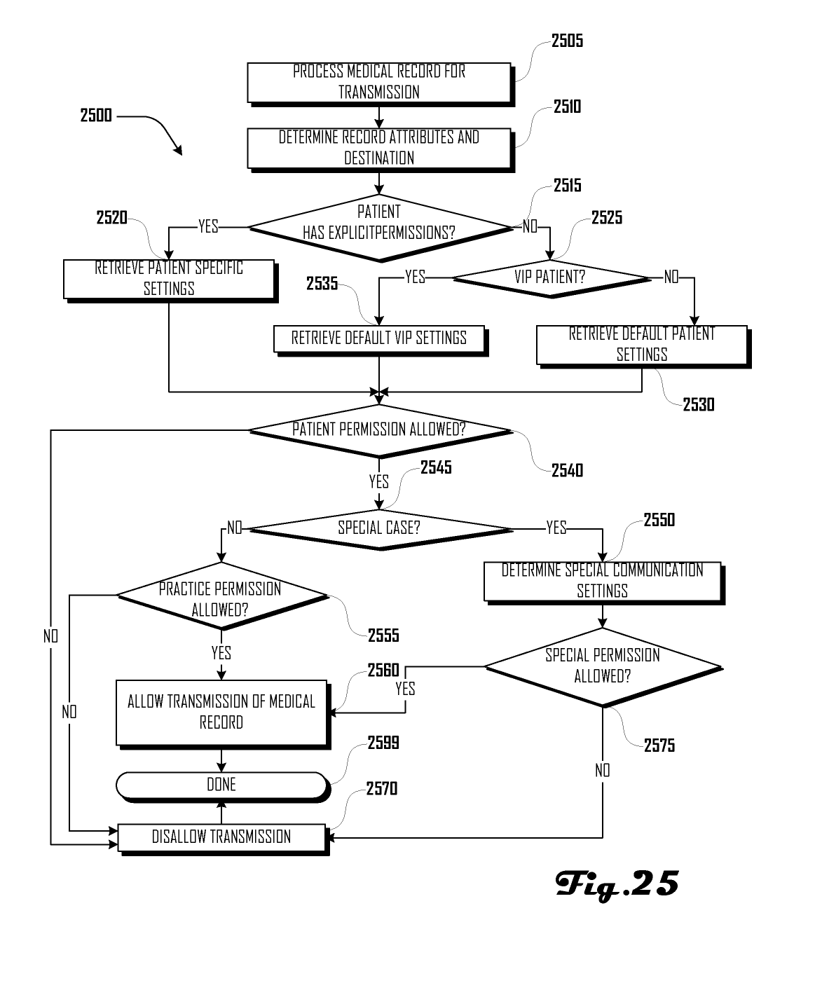

FIG. 25 Illustrates one exemplary medical record transmission process where outbound transmissions of medical records are processed to determine if they should leave a practice. Medical record transmission processing routine 2500 begins at block 2505 where a medical record is processed for transmission outside a practice. In block 2510 the medical record attributes and destination are determined for the processed transmission. In decision block 2515, a check is made to see if the patient has explicit settings for determining the privacy rules to apply. If so, the patient specific privacy settings are retrieved in 2520. If not, decision block 2525 checks to see if the patient is designated as a VIP. If so, the default settings applicable for a VIP patient is retrieved in block 2535. If the patient is not a VIP, the default settings for patients is retrieved in block 2530. In decision block 2540 the medical record's attributes (e.g., automatically determined or manually assigned attributes) are examined to determine if the patient to which the medical record corresponds with have given permission for records having the determined attributes to be transmitted outside the practice.

For example if a patient has given permission for mental health related medical records to be transmitted outside the practice and the medical record is determined to have a mental health attribute, then there would be patient permission for that record to be sent out, so long as there are no other attributes that the patient has indicated that should not be allowed. For example, in one situation a record may be flagged with an attribute of “mental health” and “sexually transmitted disease” attributes, but only the mental health record is permitted to leave the practice by the patient and not the sexually transmitted disease record. Accordingly, the record would not be permitted to be sent, because if any attribute of a medical record is not allowed for transmission, no transmission would be allowed.

Returning to FIG. 25, if all the attributes of the medical record are permitted by the patient, processing proceeds to decision block 2545 to determine if there is a special case for transmitting records outside the practice to the determined destination for the medical record. If in decision block 2545 it is determined that there is a special case, processing proceeds to block 2550 where the special communication settings are determined. Next, in decision block 2575, a determination was made whether given the special case; the record would be permitted to leave the practice.

For example, a practice may have a general rule as to the types of records it would allow to be shared with other medical practices, however in certain scenarios where there are either more permissive or more restrictive communication settings that are desired, a practice may restrict or loosen their communication setting. One example might be between a hospital and an associated clinic that has a close relationship with the hospital. In general, the hospital might not wish to share most of its medical records with other practices; however the hospital may allow more records to be shared with its closely related clinic.

Accordingly, if in decision block 2575 it is determined the special permission is allowed, in block 2560 the transmission of the medical record is allowed. If however in decision block 2575 the special permission would not allow the transmission of the medical record, processing proceeds to block 2570 where the transmission is disallowed. Returning to decision block 2545, where it was determined that no special case is required, then in decision block 2555 a determination is made whether to allow the transmission of the medical record based on the practices general/default settings. If allowed, processing proceeds to block 2560. If, however, in decision block 2555 it was determined that the attributes of the medical record would not indicate that the medical record should be transmitted, processing would proceed to block 2570. Similarly, in decision block 2540 if it was determined that the patient permissions would not allow medical record having the determined attributes to be transmitted outside the practice, processing would proceed to block 2570, after which routine 2500 would end at block 2599.

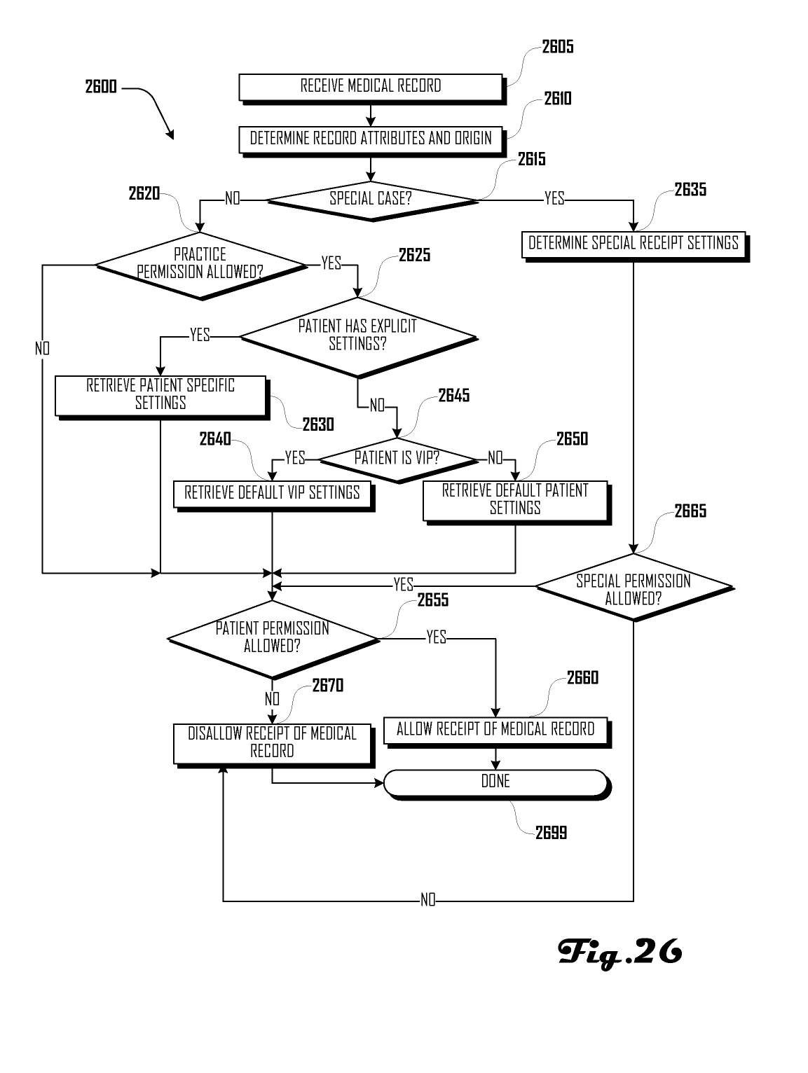

Similar to medical record transmission processing routine 2500, FIG. 26 illustrates a medical record receipt processing routine 2600. Medical record receipt processing routine 2600 begins at block 2605 where a medical record is received. In block 2610 a determination is made as to the attributes of the received medical record and its origin (e.g., the practice from which it was transmitted). Next, in decision block 2615 a determination is made whether there is a special case for medical records received from the originating practice. If so, processing proceeds to block 2635 where the special receipt settings are determined. In decision block 2665 a determination is made whether there is special permission to allow receipt of the medical record. If so, processing proceeds to decision block 2655 where determination is made whether the patient corresponding to the medical record at the receiving practice will allow receipt of medical records having the determined attributes (and potentially from the originating practice as well). If so, processing proceeds to block 2660 where the receipt of the medical record is allowed and medical record receipt processing routine 2600 ends at block 2699.

Returning to decision block 2615, if it was determined that no special case exists for the received medical record, processing proceeds to decision block 2620 where determination is made as to whether the practices general/default settings allow receipt of a medical record having the listed attributes. If so, processing proceeds to decision block 2625 where a determination is made if the patient in question has an explicit rule set for receipt of information. If such patient specific rules are set, these settings are retrieved in block 2630. Otherwise, block 2645 checks if the patient is a VIP patient. If the patient is a VIP patient, the default VIP settings are retrieved in block 2640. Otherwise, the default patient receive settings are retrieved in block 2650. Next, processing proceeds to block 2655 and routine 2600 proceeds as described above. If in decision block 2620, decision block 2655 or decision block 2665 it was determined that permission was not allowed, processing would proceed to block 2670 where receipt of the medical record would be disallowed and routine 2600 would end at block 2699.

Though not specifically called out in the screen shots and routines listed above, in some embodiments, an attribute of a medical record may be set explicitly as a “do not share” attributes such that any decision as to transmission and/or receipt of the medical record would always fail such that the record would never be shared with other practices.

Likewise, in similar embodiments, practices, groups of practices (and/or patients) may have specially determined relationships that affect communications. One issue with maintaining a list of practices is that the overall practice list might change at later points in time. Hence, if the original pool of practices had 30 members, and you selected 10 of those as valid practices that data can be exchanged with, two months later there might be 50 practices. Question arises on how to handle the new 20 practices.

Accordingly, in some embodiments a “White List” may be maintained. A White List is a list of practices with which information can be exchanged with, with the assertion that new practices in the network are considered outside the white list. Therefore, any new practices may be excluded from the exchange of information.

Alternate embodiments may use a “Black List.” A Black List is a list of practices with which information cannot be exchanged with, with the assertion that new practices in the network are considered outside the Black List, and hence data can be exchanged with them. New practices are thus included in the exchange of information.

Accordingly, if the user selects a group of practices to exchange data with and says new practices cannot be included in data exchange, he is effectively creating a White List of the selected practices.

If the user selects a set of practices to exchange data with and allows new practices to be included in data exchange, the user is effectively creating a Black List of the inverse of the selected practices.

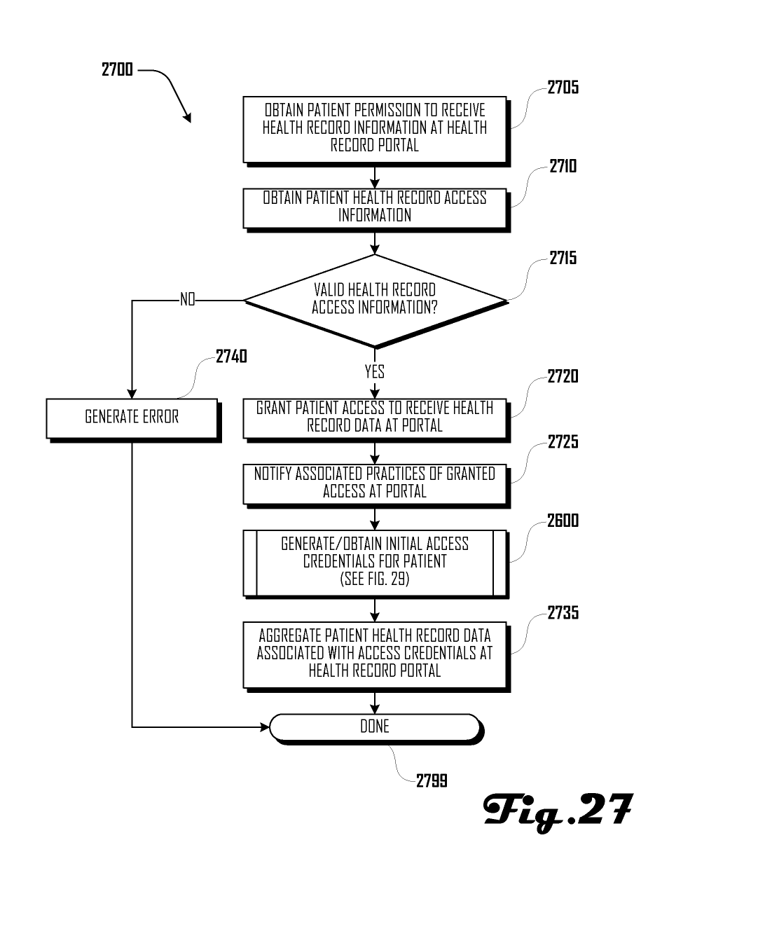

FIGS. 27-29 illustrate the privacy settings implemented with patient access. FIG. 27 illustrates an exemplary flow diagram of a patient authentication routine 2700. Patient authentication routine 2700 begins at block 2705, where a patient's permission to receive personal health record information via a health record portal site is obtained. Next, in block 2710, the patient personal health record access information is obtained. Personal health record access information may include identification information, such as a government-issued identification information, and the like; additionally, personal health record access information may include information matching the patient to records at a practice affiliated with the health record portal or within a health information network. In decision block 2715 it is determined whether the personal health record access information is valid. If so, processing proceeds to block 2720. If, however, the personal health record access information is invalid, processing would proceed to block 2740 where routine 2700 would error out and end at block 2799.

In block 2720, the health record portal site is granted access to receive personal health record data for the patient at the portal site. In block 2725, zero or more practices associated with the user are notified of the intent by the patient to receive personal health record data at the personal health portal site. In one embodiment, the patient is provided a unique PIN number, which has to be provided along with a government-issued ID to on-site practice attendants to validate the patient's identity. After the patient's identity has been validated on location at a practice selected by the patient, access can be granted to the health record portal site to receive personal health record data for the patient.

In one embodiment, this notification may generate an exception to the publication policies of the practices such that the user would be granted access to receive the personal health record information from each of their practices that they had visited even if other practices would not have been granted access to those health records. In subroutine block 2900, initial access credentials are generated/obtained for the patient and in block 2735, the personal health record data for the patient is aggregated at the portal site for access by the patient. Routine 2700 then ends at block 2799.

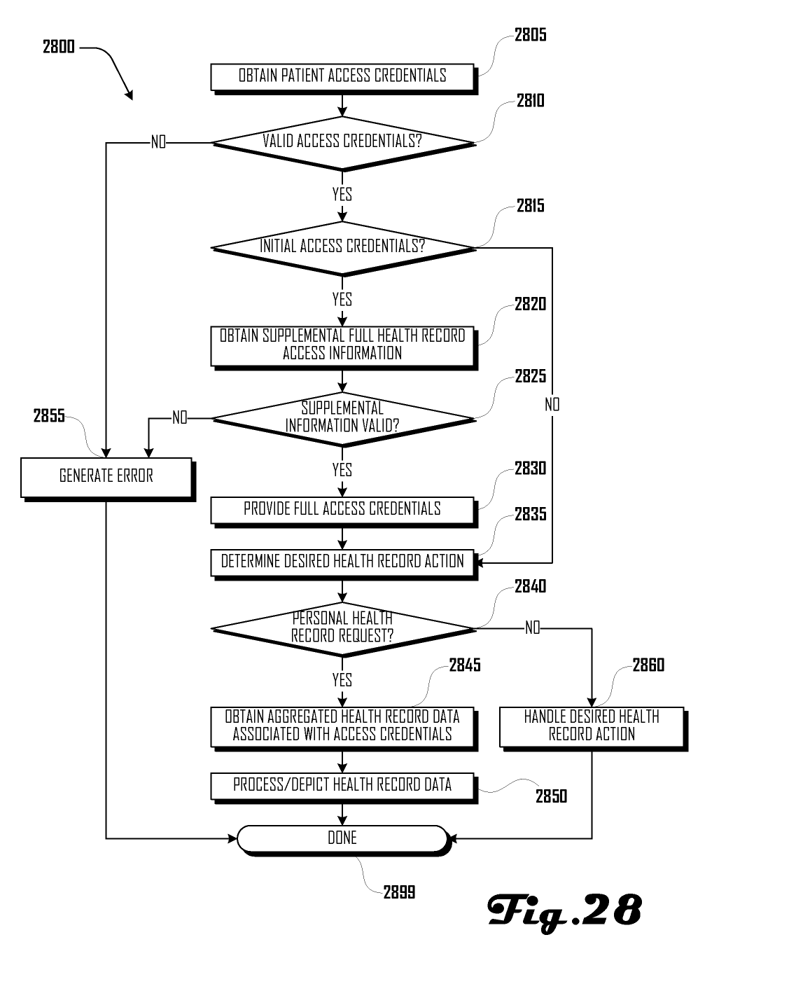

FIG. 28 illustrates an exemplary patient sign-on routine 2800 to a health record portal. Sign-on routine 2800 begins at block 2805 where access credentials for a patient are obtained. In decision block 2810, a determination is made whether the access credentials are valid. If access credentials are not valid, processing proceeds to block 2855 where sign-on routine 2800 errors out and then ends at block 2899. If, however, at decision block 2810, it was determined the access credentials are valid, processing proceeds to decision block 2815 where a determination is made whether the access credentials are initial access credentials, and if so, processing proceeds to block 2820 where supplemental access information is obtained.

In one exemplary embodiment, obtaining full access credentials may involve the user answering one or more challenge-response questions that would not necessarily be known to anyone in a health information network and/or practices associated with the patent, but would be known to the patient. For example, in one embodiment, a patient maybe asked to select which doctor they had visited in the last year from a list of five doctors, to choose a medication that had been prescribed to them within the last six months from a list of selected medications, or the like. In a still further embodiment, other challenge-response questions may be used, including challenge response questions previously selected or designated by a patient, and the like.

Sign-on routine 2800 proceeds to decision block 2825 where a determination is made whether the supplemental access information is valid. If so, processing proceeds to block 2830 where full access credential are provided. If, however, the supplemental access information was invalid, the sign-on routine 2800 errors out at block 2855.

After full access has been granted (or if in decision block 2815 it was determined that the valid access credentials were not initial credentials) processing proceeds to block 2835 where the desired actions of the personal health record portal are determined. In decision block 2840, if it is determined that the desired personal health record action is a personal health record data request, processing proceeds to block 2845 where the aggregated personal health record data associated with the patient (i.e., with the patient's access credentials) is obtained. Next, the personal health record data is provided, presented and/or depicted for the user in block 2850 and sign-on routine 2800 ends at block 2899. If in decision block 2840 it was determined that the desired action is not a personal health record data request, in block 2860 the desired personal health record action is handled, and sign-on routine 2800 ends at block 2899.

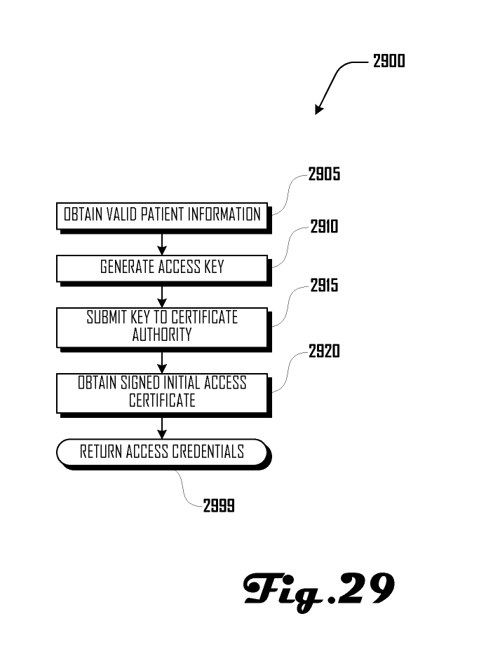

FIG. 29 illustrates an exemplary access credential generation subroutine 2900. Access credential generation subroutine 2900 begins at 2905 where valid patient access information is obtained. In block 2910 an access key associated with the patient access information is generated. In block 2915, the access key is submitted to a certificate authority. Next, in block 2920, the signed initial access certificate is obtained from the certificate authority. In some embodiments the certificate authority may reside on the same device that is executing access credential generation subroutine 2900. In return block 2999, the initial access certificate is returned to the calling patient authentication routine 2700.

In some embodiments, patients may add information to their personal health records via a health record portal. For example, patients may list non-prescription medications they are taking, other health related activities they may be engaged in, such as exercise, dieting, and the like. Furthermore, in many embodiments the health record portals are built to be extensible and may allow both information depicted for the patient and/or raw sharing of data, e.g. in XML format (in some instances known as API access). In such raw data access embodiments, health record information may be provided to a client application on a client device 110 or an external device 120, and need not be formatted and/or edited via an online interface such as a Web page.

In certain embodiments, a health record aggregator (such as an aggregator server device, not shown) may sign in to multiple health record portals aggregate a patient's health records between the health information network.

In a still further embodiment, a patient can organize and schedule health treatments, “Check in” for doctor's appointment, and post visit documentation via a health record portal. In various embodiments, patients can directly control their Personal Health Record (“PHR”) subscriptions (e.g., from which practices he/she is getting data and the like) and PHR publications, e.g., which practices he/she is permitting PHR view or datafile to be made available; “view” means it is a real time query to the latest PHR data. A “datafile” may be pregenerated (also possibly encrypted) by the patient so he/she can exactly see what data he/she is giving to a given practice.).

In one embodiment, patients can exchange text messages with physicians regarding general healthcare matters, regarding a specific piece of clinical information, (e.g. a specific medication), or the like. Such text messages can contain attachments of any type and the messages can be secure.

Additionally, in further embodiments, a patient can request changes to how his/her data is shared in the health network and may or may not be able to configure the permission settings of a health provider appliance. For example, patient can request that Dr. Smith at Practice A to stop receiving patient's data from other practices, but patient cannot directly change the settings on Dr. Smith's health provider appliance to opt out of receiving such updates; alternatively, patient can request Dr. Smith at Practice A stop receiving patient's data from other practices and can configure Dr. Smith's health provider appliance to opt out of receiving such updates.

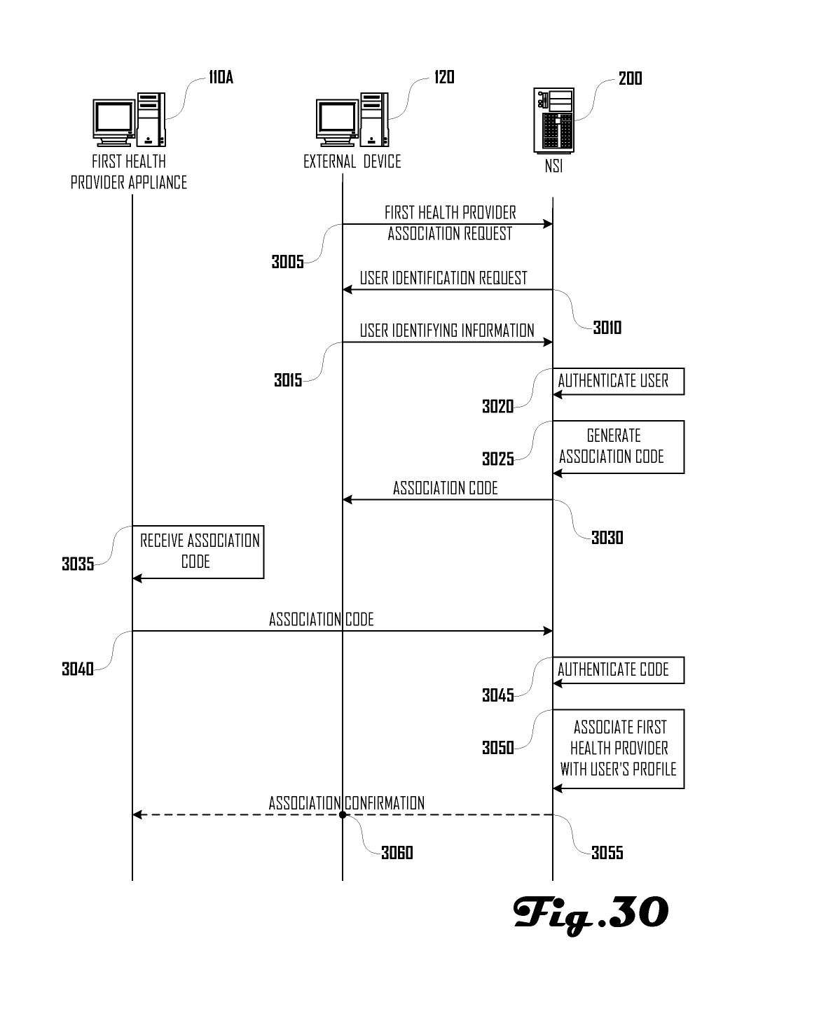

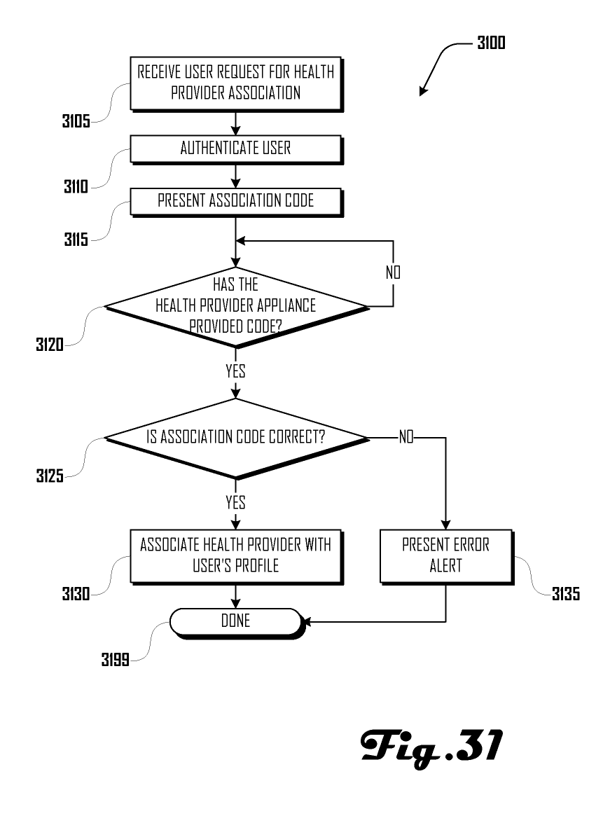

The following FIGS. 30-31 depict exemplary user registration actions and routines in accordance with various embodiments. For example, in one embodiment, it can be desirable to require a high degree of identity verification if a patient's health records are to be released or otherwise obtained by a party that is not the patient or the health provider that created the document. As such, a user can be required to obtain an association code by supplying identifying information, and then appearing at a health provider to provide additional identification to the health provider in order to have the health provider associated with the user's user account.

FIG. 30 is a diagram illustrating user registration actions taken by a first health provider appliance 110A, an external device 120, and an NSI 200, in accordance with various embodiments. The actions begin where a first health provider association request is sent 3005 to the NSI 200 from the external device 120. In one embodiment, a patient can create a patient account. The NSI 200 sends 3010 a user identification request to the external device 120, which in one embodiment, can comprise a request to provide identifying information such as social security number, address, a member account number, a password, date of birth, personal information, government issued identification, and the like. The external device 120 sends 3015 user identifying information to the NSI 200, where the user identification information is authenticated 3020 and thereby the identity of a user configuring the external device 120 is authenticated. The NSI 200 generates 3025 an association code and sends 3030 the association code to the external device 120, which in one embodiment the association code can comprise one or more character, numeral, symbol, phrase, or the like. For example, in one embodiment, the association code can be a four-digit personal identification number (“PIN”).

The first health provider appliance 110A can receive 3035 the association code and send 3040 the association code to the NSI 200, where the association code is authenticated 3045, and the first health provider and first health provider appliance 110A associated with the fist health provider are associated 3050 with the user's profile. In optional steps, an association confirmation is sent 3055 to the external device 120, and an association confirmation is sent 3060 to the first health provider appliance 110A. In one embodiment, a user can receive an association code sent 3030 from the NSI 200 and appear physically at the first health provider to provide the association code to the first health provider such that the association code is received 3035 by the first health provider appliance 110A associated with the first health provider. In one embodiment, a user or patient can be required to provide identifying information when presenting the association code to the health provider, and identifying information can also be sent 3040 along with the association code to the NSI to allow for user/patient authentication.

For example, in another embodiment, a patient user may desire to allow a health provider to obtain health records associated with the user. To facilitate this, the user can initiate steps to associate the first health provider and the first health provider appliance 110A that is associated with the first health provider to the user's user profile. The user can obtain 3030 an association code generated 3025 by the NSI 200, and would be required to be physically present at the first health provider to provide the association code to the first health provider along with other identifying information such as date of birth, a drivers' license, passport, social security card, photo identification, a credit card or the like. The health provider can send 3040 the association code to the NSI 200 so that the code can be authenticated 3045, which allows for the user's profile to be associated 3050 with one or more of the first health provider, the first health provider appliance 110A, and one or more health practitioner practicing at the health provider. In a further embodiment, a user can be presented with a list of health providers that the user can request be associated with the user's profile.

FIG. 31 is a user registration routine 3100, in accordance with various embodiments. In block 3105, a request for health provider association is received from a user and in block 3110 user identification is authenticated. For example, in one embodiment, user identification can be authenticated by a user providing personal identification or information as described herein. In block 3115, an association code is presented to the user and in block 3120 a determination is made whether the health provider device associated with the health provider that the user requested association with has provided the association code that was presented to the user. If the health provider has not provided the code, the user registration routine 3100 cycles back to decision block 3120, where a determination is again made whether the health provider device associated with the health provider that the user requested association with has provided the association code that was presented to the user. However, if the association code has been provided by the health provider, the user registration routine 3100 continues to decision block 3125, where a determination is made whether the provided association code is correct. If the association code is not correct, the user registration routine 3100 continues to block 3135, where an error alert is presented, and the user registration routine 3100 is done 3199. However, if the association code is correct, the user registration routine 3100 continues to block 3130, where the health provider and health provider are associated with the user's profile and the user registration routine 3100 is done 3199.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, while only three appliances 300A-C have been described, in further embodiments, many more appliances may be used. This application is intended to cover any adaptations or variations of the embodiments discussed herein.

1. A computer-implemented method of patient authentication for health record access via a health record portal, the method comprising:
obtaining a patient permission to receive health record information via a health record portal;
obtaining patient health record access information;
determining if said patient health record access information is correct;
granting patient access to health record information via said health record portal if said patent health record access information is correct;
determining a practice applicance associated with said patient;
notifying said associated practice appliance of said patent access to health record information via said health record portal; and
presenting health record information via said health record portal.

2. The method of claim 1, wherein said patient health record access information comprises personal identification information.

3. The method of claim 2, wherein said patient health record access information further comprises personal information corresponding to information contained in a health record associated with said patient.

4. The method of claim 1, wherein said associated practice device is determined by using a Master Person Index.

5. The method of claim 4, wherein said practice device is operationally connected to a Secure Trusted Network.

6. The method of claim 1, further comprising the step of obtaining initial access credentials for said patient.

7. The method of claim 7, wherein the further step of obtaining initial access credentials for said patient comprises:
generating an access key;
submitting said access key to a certificate authority; and
obtaining a signed initial access certificate.

8. A computer readable medium having computer executable instructions for performing the method of claim 1.

9. A computing apparatus comprising a processor and a memory having computer executable instructions for performing the method of claim 1 when executed by said processor.

10. A computer system for patient authentication for health record access via a health record portal, the system comprising:
a means for obtaining a patient permission to receive health record information via a health record portal;
a means for obtaining patient health record access information;
a means for determining if said patient health record access information is correct;
a means for granting patient access to health record information via said health record portal if said patent health record access information is correct;
a means for determining a practice applicance associated with said patient;
a means for notifying said associated practice appliance of said patent access to health record information via said health record portal; and
a means for presenting health record information via said health record portal.

11. The computer system of claim 10, wherein said patient health record access information comprises personal identification information.

12. The computer system of claim 11, wherein said patient health record access information further comprises personal information corresponding to information contained in a health record associated with said patient.

13. The computer system of claim 10, wherein said associated practice device is determined by using a Master Person Index.

14. The computer system of claim 13, wherein said practice device is operationally connected to a Secure Trusted Network.

15. The computer system of claim 10, further comprising a means for obtaining initial access credentials for said patient.

16. The method of claim 15, wherein the means for obtaining initial access credentials for said patient comprises:
a means for generating an access key;
a means for submitting said access key to a certificate authority; and
a means for obtaining a signed initial access certificate.

17. A computer-implemented method of user account association with a health provider appliance, the method comprising:
obtaining a user request for association of a health provider appliance with a user account from a user device;
authenticating the identity of said user;
generating and presenting an association code to said user device;
obtaining said association code from said health provider appliance; and
associating said user account with said health provider appliance.

18. The method of claim 17, wherein authenticating the identity of said user comprises obtaining personal identification information corresponding to said user.

19. The method of claim 17, further comprising a step wherein said user presents personal identification information and said association code to a health provider associated said health provider appliance before said association code can be obtained from said health provider applicance.

20. The method of claim 17, wherein said health provider appliance is operationally connected to a Secure Trusted Network.
